(19) United States
(12) Patent Application Publication
(10) Pub. No.: US 2013/0152748 A1
(43) Pub. Date: Jun. 20, 2013

(54) Split Frame Lathe

(71) Applicants: Miroslaw Wokan, Elmhurst, IL (US); Andrew Shard, Grayslake, IL (US); Eric Rasmussen, Grayslake, IL (US); Mark Rasmussen, Grayslake, IL (US)

(72) Inventors: Miroslaw Wokan, Elmhurst, IL (US); Andrew Shard, Grayslake, IL (US); Eric Rasmussen, Grayslake, IL (US); Mark Rasmussen, Grayslake, IL (US)

(21) Appl. No.: 13/722,691

(22) Filed: Dec. 20, 2012

Related U.S. Application Data
(60) Provisional application No. 61/578,087, filed on Dec. 20, 2011.
(60) Provisional application No. 61/691,435, filed on Aug. 21, 2012.

(51) Int. Cl. B23B 5/08

(52) U.S. Cl. CPC B23B 5/08
USPC 82/113

(57) ABSTRACT

A split frame lathe having improved locking, cutting and adjustment capabilities is disclosed. The split frame lathe includes an embodiment having a plurality of internal bearing systems where each internal bearing system includes an eccentric bushing, a bearing pin and a v-bearing. Another embodiment of the split frame lathe may include adjustable leg systems. The split frame lathe may also include a star gear connected to a gear ring where the star gear can be rotated in a first direction and, alternatively, in an opposite second direction. In another embodiment the split frame lathe includes a trip system to prevent damage to the lathe and harm to the operator. The split frame lathe may also include improved locking mechanisms for the gear and base ring and a hinge system. The split frame lathe also may include a counter bore and flange facer attachment.

### BACKGROUND OF THE INVENTION

This invention relates to split frame lathes typically used in the pipe cutting and weld prepping industries, and more particularly to a split frame lathe having improved locking and adjustment mechanisms and cutting capabilities.

Split frame lathes are used in a variety of industries where precision welded piping systems are essential, such as power generating facilities, manufacturing facilities, and petrochemical plants. The need for these lathes in these industries often require the lathes be used in harsh environments including nuclear power plants, underwater, offshore oil rigs, or other hazardous conditions. These environments demand that downtime due to setup, operation and maintenance of equipment be minimized.

There is a need for a more durable split frame lathe design, having more expansive cutting, shaping, locking and adjustment capabilities that promote more efficient and safe operation of the lathes and extend their working lifespan. For example, some existing lathes incorporate clamping mechanisms that can accidentally disengage while the machine is in use and may strip or break off entirely, which can lead to loss of productivity while the machine undergoes what can be expensive repairs. Some designs cannot readily be used on an elbow or curve, instead requiring labor and time intensive adjustment by way of tapping the clamping mechanisms with a piece of brass and a hammer in order to adjust for curvature. In some lathe designs, some of the parts wear quickly and are difficult to replace or can become damaged, which again increases down time during projects while the machine undergoes maintenance and repairs. Some lathes also have a propensity for becoming misaligned due to inadequate locking or connecting mechanisms that lack durability. Not only does a misaligned lathe increase the potential for substantial damage to the machine, but it can also pose danger to the operator.

### SUMMARY OF THE INVENTION

A split frame lathe is disclosed including a stationary base ring that comprises a v-groove; a gear ring; a cutting tool coupled to the gear ring; and at least one internal bearing system rotatably connecting the gear ring to the stationary base ring. Each of the at least one internal bearing systems comprises: an eccentric bushing defining an off-center bore extending through an axial length of the eccentric bushing; a bearing pin inserted into the off-center bore of the eccentric bushing; a v-bearing that rotates around the bearing pin and that is in mateable relation with the v-groove; and a locking mechanism that secures the internal bearing system to the gear ring and that fixes an angular orientation of the eccentric bushing with respect to the gear ring; wherein a radial position of the v-bearing relative to the gear ring depends on an arcuate position of the off-center bore and, consequently, on the angular orientation of the eccentric bushing with respect to the gear ring.

In one embodiment, the radial position of the v-bearing, of a particular one of the at least one internal bearing systems, relative to the gear ring can be adjusted as much as about ⅛^{th} of an inch by changing the angular orientation of the eccentric bushing, of the particular internal bearing system, before the locking mechanism, of the particular internal bearing system, secures the particular internal bearing system to the gear ring.

The gear ring can comprises at least one pocket; a head of the eccentric bushing, of a particular one of the at least one internal bearing systems, nests in one of the at least one pockets; and the locking mechanism, of the particular internal bearing system, comprises a bearing clamp that holds in place the eccentric bearing, of the particular internal bearing system, fixing its angular orientation with respect to the gear ring.

The stationary base ring can have an internal surface that faces the gear ring, and an opposite-facing external surface that defines a plurality of slots that are spaced around the stationary base ring. The split frame lathe further comprises a plurality of adjustable legs for securing the stationary base ring to a workpiece, each of the plurality of adjustable legs being externally mounted to the stationary base ring in a respective one of the slots.

The split frame lathe also can include at least one pin coupled to the stationary base ring; and a slide system mounted to the gear ring, the cutting tool being mounted to the slide system. The slide system comprises a star gear that can be rotated both in a first direction and, alternatively, in an opposite second direction; and gearing that converts rotation of the star gear in the first direction into radially inward movement of the cutting tool, and that converts rotation of the star gear in the second direction into radially outward movement of the cutting tool; wherein each of the at least one pins is positioned and dimensioned to engage the star gear during normal rotation of the gear ring relative to the stationary base ring, so that the pin causes the star gear to rotate a predetermined amount with each engagement between the pin and the star gear, and so that the pin can cause the star gear to rotate in the first direction and, alternatively, in the second direction depending on a direction in which the gear ring is rotating relative to the stationary base ring.

The cutting tool can comprise an automated counter bore attachment that is structured and dimensioned to be positioned inside a workpiece and to cut an interior surface of the workpiece.

The split frame lathe also can include at least one pin coupled to the stationary base ring; and a flange facer mounted to the gear ring, the cutting tool being mounted to the flange facer and being structured and dimensioned to be positioned at an axial end of a workpiece. The flange facer further comprises: a rotatable star gear, with each of the at least one pins being positioned and dimensioned to engage the star gear during normal rotation of the gear ring relative to the stationary base ring, so that the pin causes the star gear to rotate a predetermined amount with each engagement between the pin and the star gear; an automatic cross-feed assembly that is coupled to the star gear, and that converts rotation of the star gear into radial movement of the cutting tool relative to the gear ring; and a manual in-feed assembly that is structured to adjust a position of the cutting tool in an axial direction relative to the gear ring.

The split frame lathe also can include a rotatable star gear coupled to the gear ring, with the cutting tool being coupled to the star gear so that rotation of the star gear causes radial movement of the cutting tool; and at least one trip system that is rotatably mounted to the stationary base ring. Each of the at least one trip systems can comprise at least one pin, each of the at least one pins being positioned and dimensioned to engage the star gear during normal rotation of the gear ring relative to the stationary base ring, so that the pin cause the star gear to rotate a predetermined amount with each engagement between the pin and the star gear; and a trip rod that is sufficiently rigid to maintain a position the trip system during normal engagement of the at least one pin with the star gear, but that is sufficiently deformable to allow the trip system to rotate out of a path any component rotating with the gear ring if any of the at least one pins engages any object other than the star gear.

The split frame lathe also can include a hinge system connecting first and second halves of the stationary base ring at two interfaces between the first half and the second half of the stationary base ring. The hinge system comprises a first hinge element mounted to the first half of the stationary base ring; a second hinge element mounted to the second half of the stationary base ring, the second hinge element defining an elongated opening; and a fastener extending through the elongated opening of the second hinge element, and connecting the first and second hinge elements to each other while allowing them to slide and to pivot with respect to each other when the fastener is free to move laterally and to rotate within the elongated opening of the second hinge element.

The stationary base ring can comprise two complimentary halves, each half of the stationary base ring having an inner circumferential surface and an outer circumferential surface; wherein the two halves of the stationary base ring meet at two interfaces and are locked together by at least one joining member; and wherein each of the at least one screws enters one of the two halves of the stationary base ring through the outer circumferential surface of that one of the two halves, and extends across one of the two interfaces and into the other one of the two halves of the stationary base ring. Each of the at least one joining member extends through one of the two interfaces at a point that is located about three times further from the outer circumferential surfaces of each of the two halves than it is located from the inner circumferential surfaces of each of the two halves of the stationary base ring.

The gear ring can comprise two complimentary halves, each half of the gear ring having an inner circumferential surface and an outer circumferential surface. Each one of the two halves of the gear ring defines a locking assembly pocket that is located further from the outer circumferential surface of that half of the gear ring than it is located from the inner circumferential surface of that half of the gear ring. One of the two halves of the gear ring defines a pin hole that extends from the outer circumferential surface of that half of the gear ring to the locking assembly pocket of that half of the gear ring. The two halves of the gear ring meet at two interfaces and are locked together by a locking assembly, the locking assembly comprising a locking member and at least two elongated fasteners. The two locking assembly pockets meet at one of the two interfaces, the locking member is disposed in the two locking assembly pockets and extends across the one of the two interfaces, one of the at least two elongated fasteners extends through the pin hole of the gear ring and into the locking member, and another one of the at least two elongated fasteners extends in a generally axial direction with respect to the gear ring and joins the locking member to the gear ring.

In an alternative embodiment, the split frame lathe comprises a stationary base ring having an internal surface, and an opposite-facing external surface that defines a plurality of slots that are spaced around the stationary base ring; a gear ring rotatably mounted to the stationary base ring, and facing the internal surface of the stationary base ring; a cutting tool coupled to the gear ring; and a plurality of adjustable legs for securing the stationary base ring to a workpiece, each of the adjustable legs being externally mounted to the base ring in a respective one of the slots. Each of the adjustable legs can comprise a leg block that is slidably connected to the stationary base ring and a dovetail leg disposed within a complimentary passage in the leg block. The leg block is operably connected to a first manipulating device capable of moving the leg block in a radial direction with respect to the stationary base ring. The dovetail leg is operably connected to a second manipulating device capable of moving the dovetail leg in an axial direction with respect to the stationary base ring.

Each of the adjustable legs further can comprise a locking plate for maintaining the dovetail leg in a fixed position relative to the stationary base ring.

In an alternative embodiment, a split frame lathe comprises a stationary base ring; a gear ring rotatably mounted to the base ring; a rotatable star gear coupled to the gear ring; a cutting tool coupled to the star gear, so that rotation of the star gear causes radial movement of the cutting tool; and at least one trip system rotatably mounted to the stationary base ring. Each of the at least one trip systems comprises: at least one pin, each of the at least one pins being positioned and dimensioned to engage the star gear during normal rotation of the gear ring relative to the stationary base ring, so that the pin causes the star gear to rotate a predetermined amount with each engagement between the pin and the star gear; and a trip rod that is sufficiently rigid to maintain a position the trip system during normal engagement of the at least one pin with the star gear, but that is sufficiently deformable to allow the trip system to rotate out of a path any component rotating with the gear ring if any of the at least one pins engages any object other than the star gear. The trip rod can be a screw with one end beveled to a point.

In an alternative embodiment, a split frame lathe comprises: a stationary base ring; a gear ring rotatably mounted to the stationary base ring; at least one pin coupled to the stationary base ring; a flange facer mounted to the gear ring; and a cutting tool mounted to the flange facer, the cutting tool being structured and dimensioned to be positioned at an axial end of a workpiece. The flange facer comprises a rotable star gear, with each of the at least one pins being positioned and dimensioned to engage the star gear during normal rotation of the gear ring relative to the stationary base ring, so that the pin causes the star gear to rotate a predetermined amount with each engagement between the pin and the star gear; an automatic cross-feed assembly that is coupled to the star gear, and that converts rotation of the star gear into radial movement of the cutting tool relative to the gear ring; and a manual in-feed assembly that is structured to adjust a position of the cutting tool in an axial direction relative to the gear ring.

The star gear can be rotated both in a first direction and, alternatively, in an opposite second direction, so that the at least one pin can cause the star gear to rotate in the first direction and, alternatively, in the second direction depending on a direction in which the gear ring is rotating relative to the stationary base ring.

The manual in-feed assembly can comprise a slide mechanism that can be moved in an axial direction relative to the gear ring, and that can be tilted to an orientation radially inward or radially outward from the axial direction.

### BRIEF DESCRIPTION OF THE SEVERAL VIEWS OF THE DRAWINGS

FIG. 1 is a view from the base ring side of the split frame lathe;

FIG. 2 is a view from the gearing of the split frame lathe;

FIG. 3 is an exploded view of the split frame lathe;

FIG. 4 is a view of two halves of the gear ring;

FIG. 5 is an exploded view of the base ring assembly;

FIG. 6 is a side view of one half of the base ring;

FIG. 7 is a view of a second half of the base ring;

FIG. 8 is an exploded view of the adjustable leg;

FIG. 9 is an exploded view of the adjustable leg system;

FIG. 10 is a view from the gear ring side of the split frame lathe with the adjustable leg system mounted;

FIG. 11 is a view from the base ring side of the split frame lathe with the adjustable leg system mounted;

FIG. 12 is an exploded view of the bearing assembly;

FIG. 13 is a view of the assembled bearing assembly;

FIG. 14 is an exploded view of the gear ring assembly;

FIG. 15 is an exploded view of the gear housing assembly;

FIG. 16 is an exploded view of the hinge system assembly;

FIG. 17 is an exploded view of the trip system assembly;

FIG. 18 is an exploded view of the slide system assembly;

FIG. 19 is an exploded view of the counter bore assembly;

FIG. 20 is a view of the split frame lathe with slide assembly attached to a pipe;

FIG. 21 is a view of the split frame lathe with counter bore assembly attached to a pipe;

FIG. 22 is a view of the counter bore assembly mounted to the split frame lathe;

FIG. 23 is a view of the assembled counter bore assembly;

FIG. 24 is a view of the assembled adjustable leg assembly;

FIG. 25 is an exploded view of the base ring;

FIG. 26A is a view of the hinge system;

FIG. 26B is a top view of the assembled hinge system;

FIG. 26C is a perspective view of the assembled hinge system;

FIG. 26D is perspective view of the assembled hinge system;

FIG. 27 is a view of the flange facer attachment mounted to the split frame lathe;

FIG. 28 is a perspective view of the flange facer attachment;

FIG. 29 is an exploded view of the flange facer attachment.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

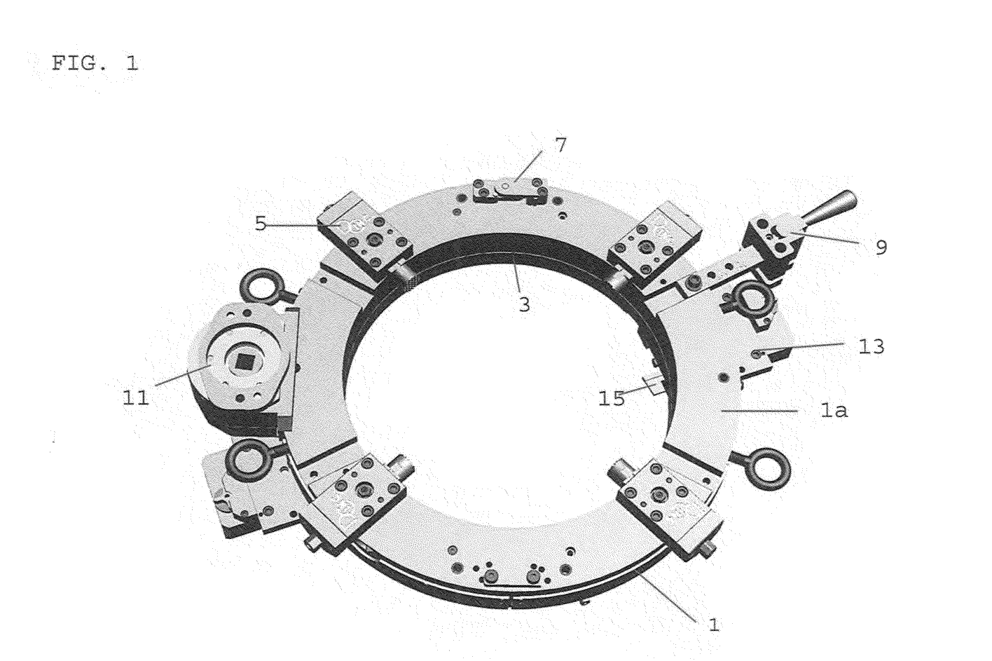

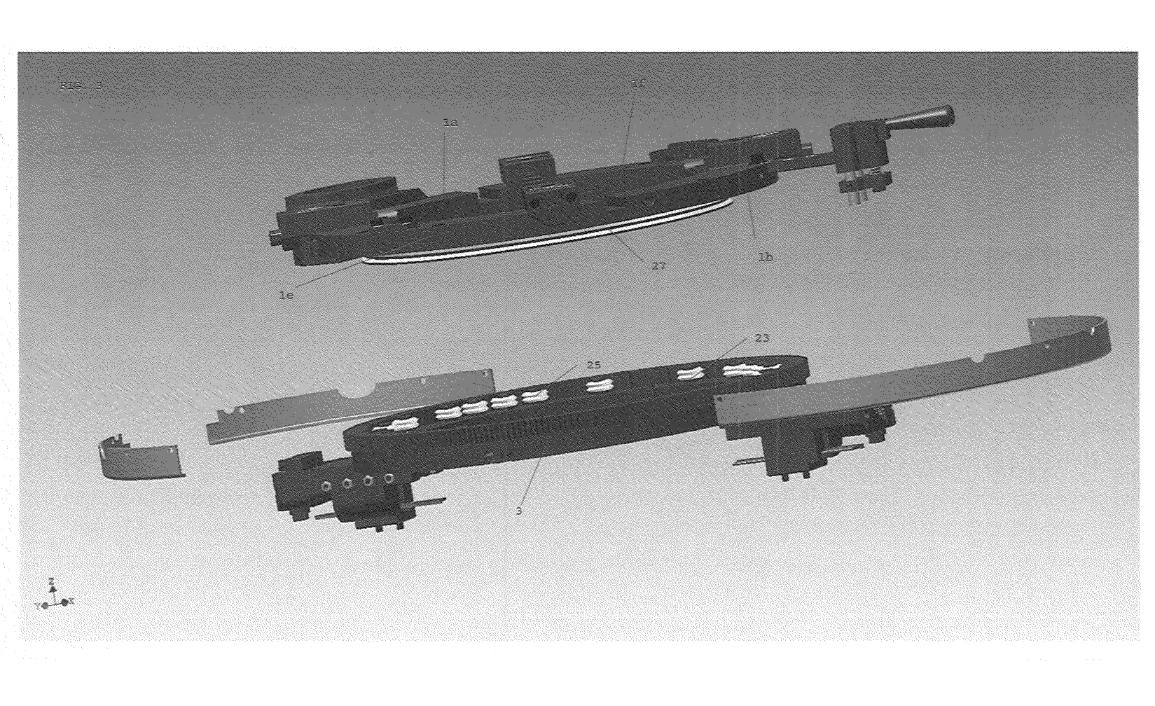

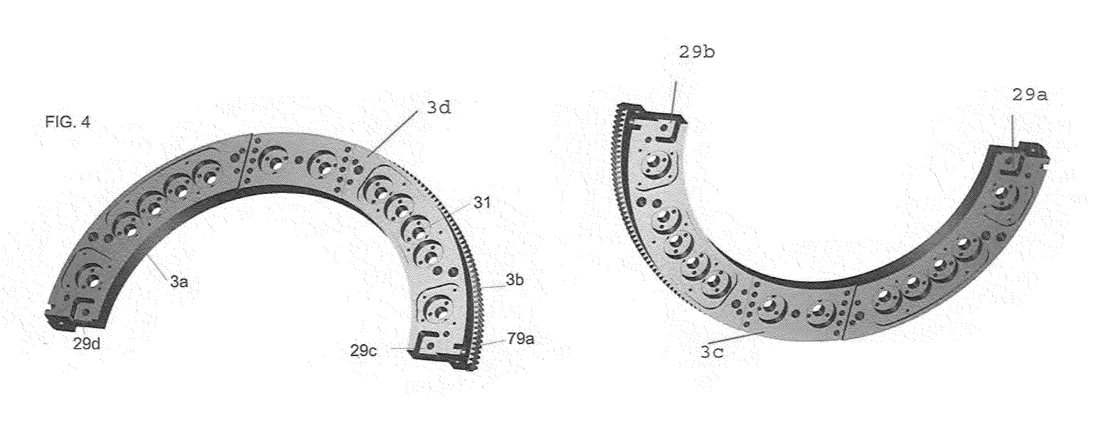

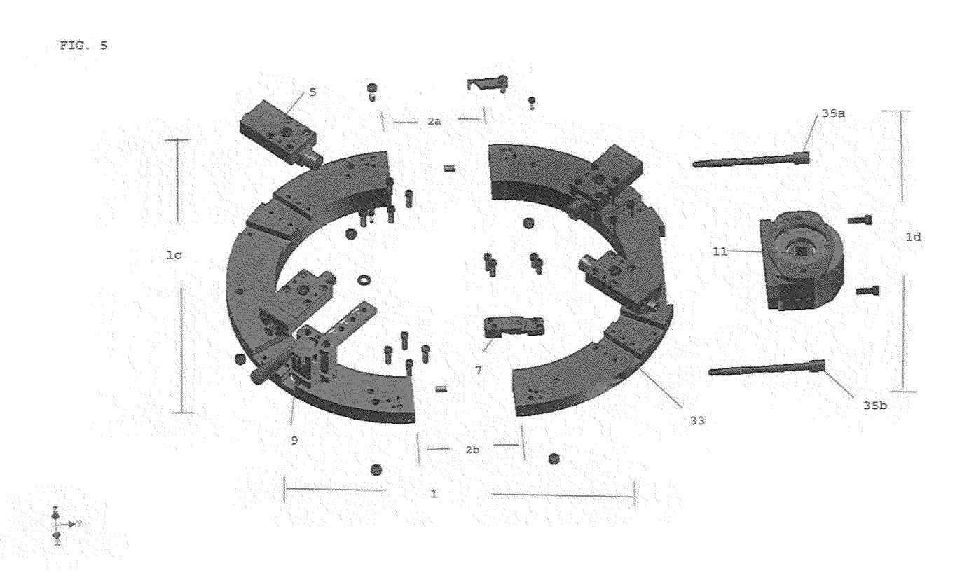

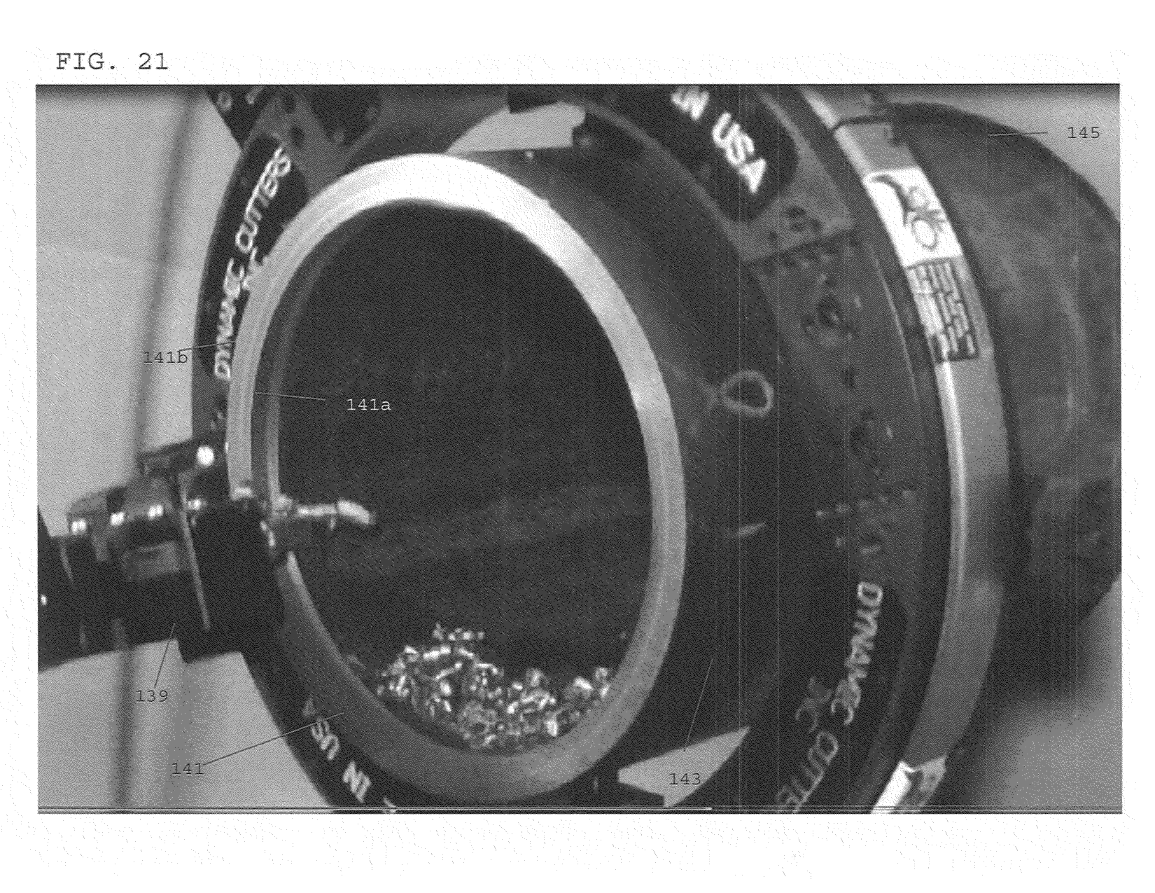

One embodiment the inventive split frame lathe is illustrated in FIG. 1. The split frame lathe includes a ring assembly comprising a base ring 1 having a first half 1c and a second half 1d (as shown in FIG. 5). The base ring is rotatably connected by an internal bearing system (as shown in FIG. 3) to a gear ring 3 having a first half 3c and a second half 3d (as shown in FIG. 4). One or more leg assemblies 5 are externally mounted to the base ring 1 to enable the split frame lathe to attach to a pipe or other workpiece. In this embodiment, the lathe also comprises a hinge assembly 7, a trip system 9, a gear housing assembly 11, and a slide assembly 13. The lathe is capable of mounting on workpieces of a variety of sizes and thicknesses. For ease of reference, the lathe's operation will be described in relation to a pipe as seen in FIG. 21 having a proximal end 143 and a distal end 145, with the proximal end being where the cutting is taking place and the distal end extending laterally along the pipe surface away from the cutting end. The pipe has an inner circumferential surface 141a and an outer circumferential surface 141b. However, it will be understood that the lathe may be employed to cut and shape a variety of other workpieces such as elbows, flanges or irregular shaped pipe. Additionally, the lathe is capable of cutting a variety of sizes, including up to two pipe sizes smaller than the lathe's specified size.

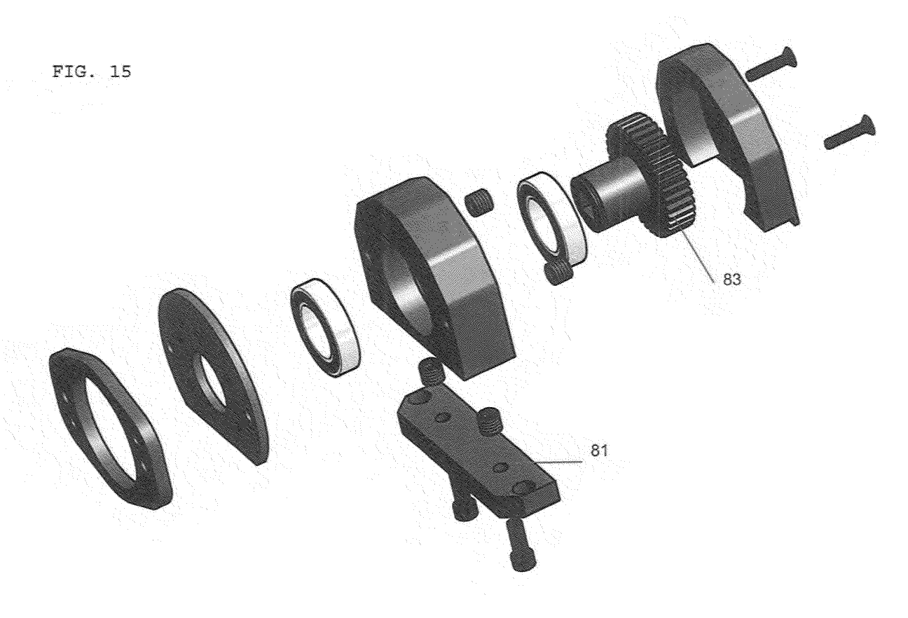

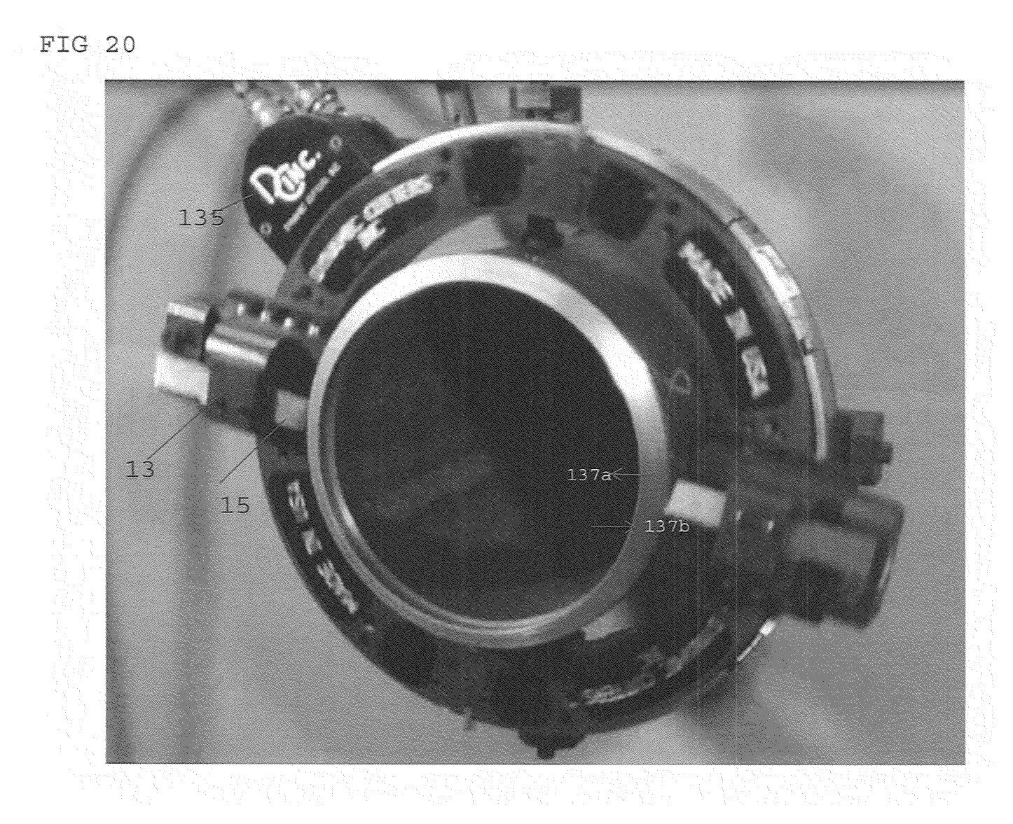

Referring back to FIG. 1, one or more cutting tools 15 may be coupled to the gear ring 3 to perform various machining operations on a pipe or other workpiece. A gear housing assembly 11 is slidably mounted to the base ring 1 by an external attachment means, such as a mounting plate 81 (as seen in FIG. 15) so that even once the base ring is fitted to a workpiece the gear housing assembly may be adjusted along the base ring. The gear housing assembly includes a drive gear 83 (shown in more detail in FIG. 15) and power source 135 (shown in more detail in FIG. 20). In a preferred embodiment the power source is externally mounted and compatible with split frame lathes of various sizes.

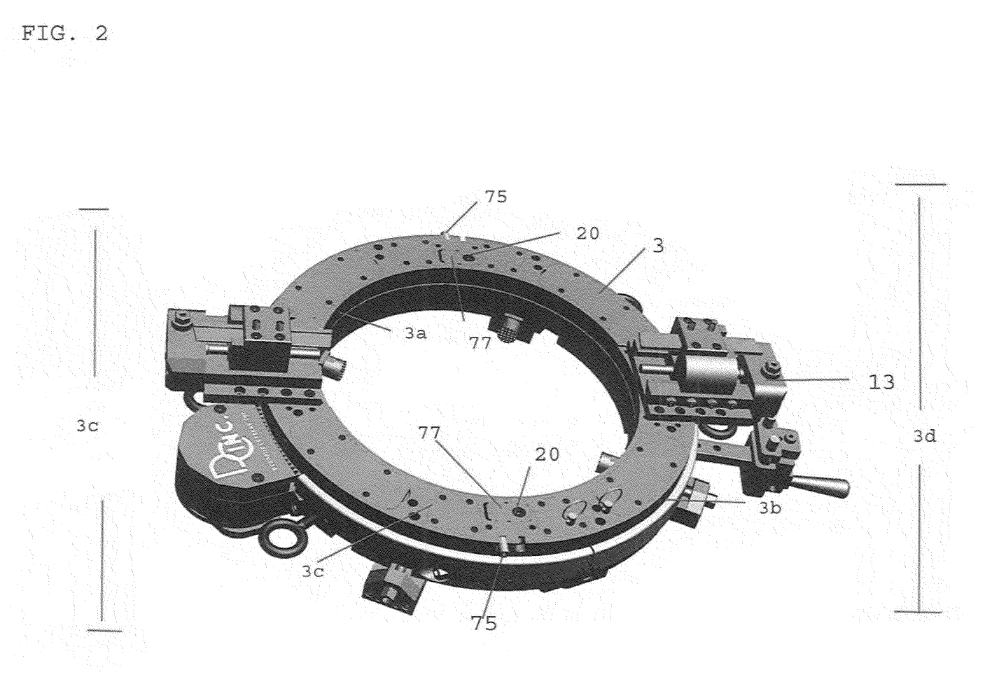

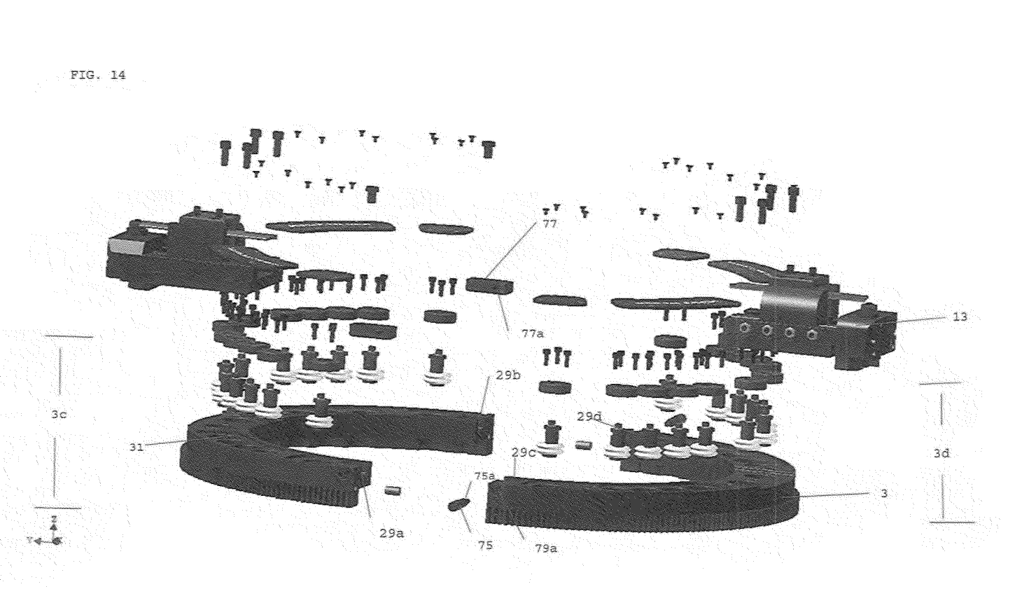

The split frame lathe from the gear ring side is detailed in FIG. 2. This embodiment shows the mounting of the slide assemblies 13 to the gear ring 3. In this embodiment, a first half 3c and a second half 3d of the gear ring meet at two interfaces and are connected utilizing one or more locking assemblies. In FIG. 2 there are two locking assemblies shown in the locked position at each of the two interfaces of the gear ring. The locking assemblies comprise a locking member 77 and two elongated fasteners 75 and 20. In FIG. 14, the two halves of the gear ring 3d and 3c includes a locking assembly pocket 29a, 29b, 29c, and 29d such that when in the locked position (as shown in FIG. 2) the locking assembly pocket will be joined at 29a and 29c and 29b and 29d. As detailed in FIG. 4, in at least one embodiment, the locking assembly pocket(s) for example, 29a, is located further from the outer circumferential surface 3b than it is from the inner circumferential surface 3a of the gear ring. In this embodiment, at least one of the two halves of the gear ring includes a pin hole 79a on the outer circumferential surface 3b of the gear ring that penetrates the locking assembly pocket 29c. Referring now to FIGS. 2 and 14, the locking assembly includes a locking member 77 and at least two elongated fasteners 20 and 75. In one embodiment, the two halves of the gear ring are locked together by inserting a locking member 77 into the locking assembly pockets 29a and 29c. The locking member extends across the interface between the two halves 3c and 3d of the gear ring. A first elongated fastener 75 is then inserted into the pin hole 79a on the outer circumferential surface of the gear ring 3 and penetrates through the gear ring to the pin hole 77a of the locking member 77. In this embodiment a second elongated fastener 20 extends in a generally axial direction with respect to the gear ring and joins the locking member 77 to the gear ring. In a preferred embodiment, the pin hole 79a has a chamfered end and a pin 75 with a corresponding chamfered end on its tip 75a is screwed into the pin hole. Additionally, as shown in FIG. 2, the second elongated fastener 20 may be inserted into the locking member 77 and into the gear ring 3 through the gear ring external surface 3e. In this embodiment, the locking mechanism is located sufficiently towards the inner circumferential surface 3a of the gear ring to hold the gear ring halves together and prevent separation when the legs are tightened around a workpiece. The locking mechanism of the present embodiment helps avoid the separation that sometimes can occur in other lathe designs that utilized some form of swing bolt for retaining the halves of the split frame lathe together, for example, when the machine separates at the joint when the legs of the base ring are tightened around a pipe or other workpiece. It also assists in maintaining the circular path of the v-groove, thus preventing premature wear on the v-bearings, v-groove and gear teeth.

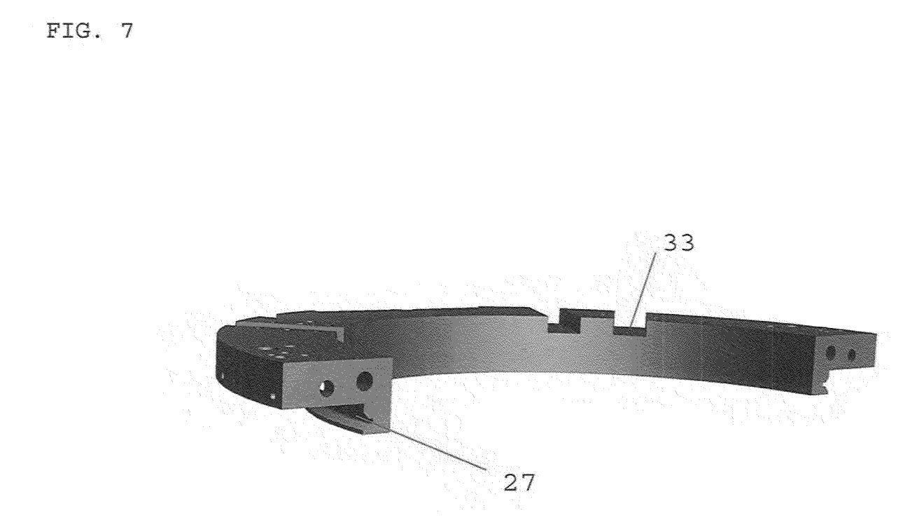

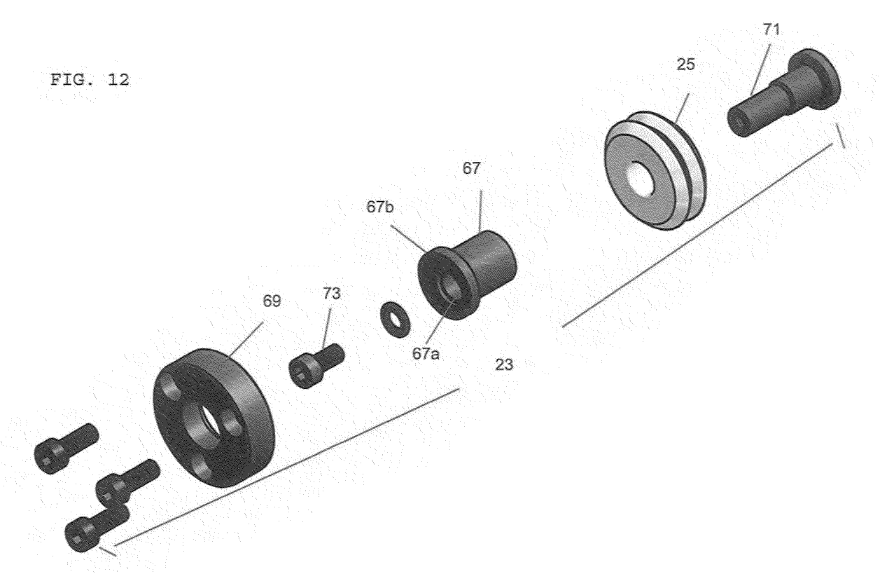

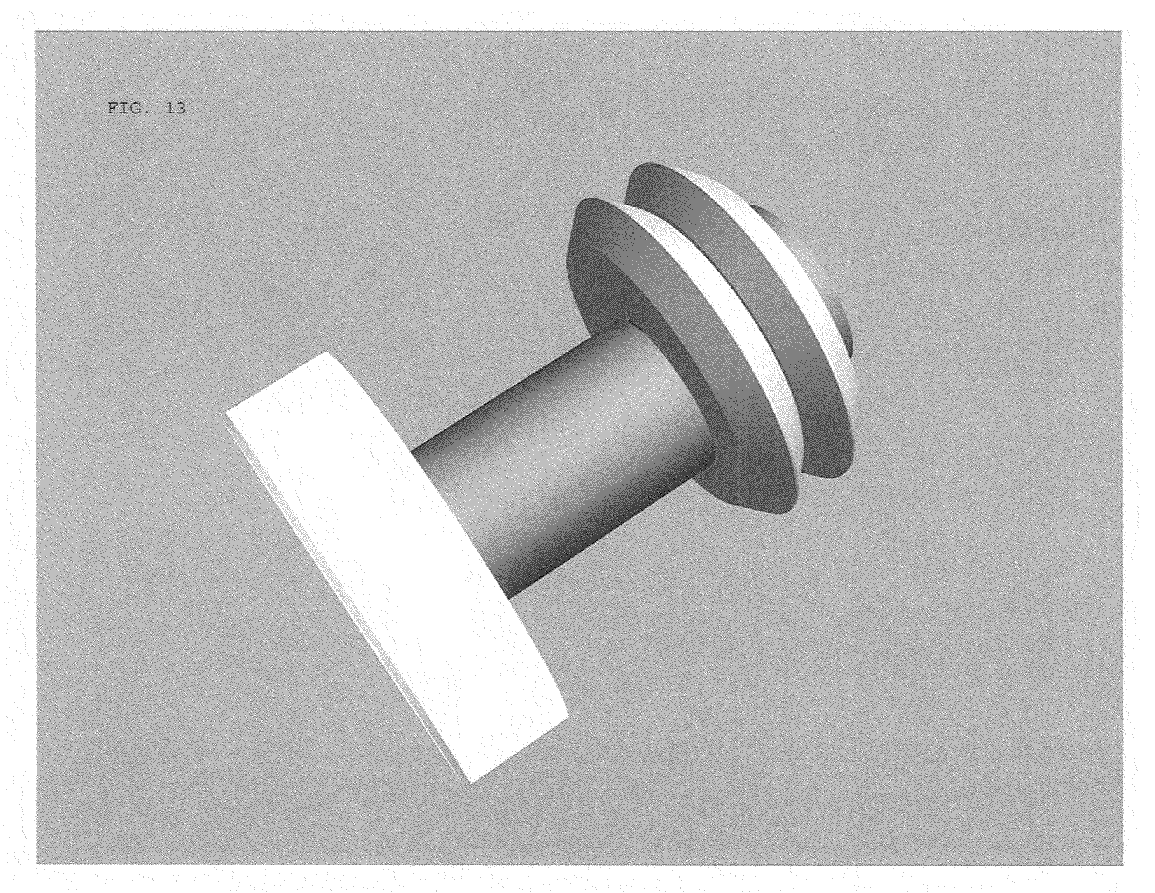

The interior of the split frame lathe assembly is detailed in FIG. 3. The gear ring 3 is rotatably connected to the base ring 1 by a plurality of internal bearing systems. The internal bearing system is depicted in FIG. 12 and comprises an eccentric bushing 67 that includes an off-center bore 67a on the head 67b of the eccentric bushing 67 that extends the length of the eccentric bushing. A v-bearing 25 rotates around a bearing pin 71 that is inserted into the off-center bore 67a of the eccentric bushing 67. An assembled internal bearing system is shown in FIG. 13. The head of the eccentric bushing 67b nests in a pocket 31 located on the gear ring as seen in FIG. 4. Referring now to FIG. 3, the v-bearing 25 then connects the gear ring 3 to the base ring 1 by mating with the v-groove 27 which is located on the base ring 1. The radial position of the v-bearing 25 relative to the gear ring can be adjusted by an adjustment of the angular orientation of the eccentric bushing. In other words, by turning the eccentric bushing the v-bearing will also turn. In a preferred embodiment, the radial position of a v-bearing 25 can be adjusted as much as ⅛^{th} of an inch by changing the angular orientation of the eccentric bushing 67. The additional adjustment allowed by the internal bearing system can extend the life of the v-groove because when the v-groove wears down it can be resurfaced and repaired and the v-bearings can be adjusted to the new dimensions of the v-groove. The internal bearing system can also include a locking mechanism designed to secure the internal bearing system to the gear ring and fix the angular orientation of the eccentric bushing with respect to the gear ring. The locking system includes bearing clamp 69 that holds the eccentric bushing 67 in place by putting downward pressure on the entire internal bearing assembly and thereby fixes the angular orientation of the eccentric bushing with respect to the gear ring. In another embodiment, the entire internal bearing system is covered by plates and held into place with one-way screws which further eliminates the turning or misalignment of the v-bearings. The v-groove 27 is further detailed in FIG. 7.

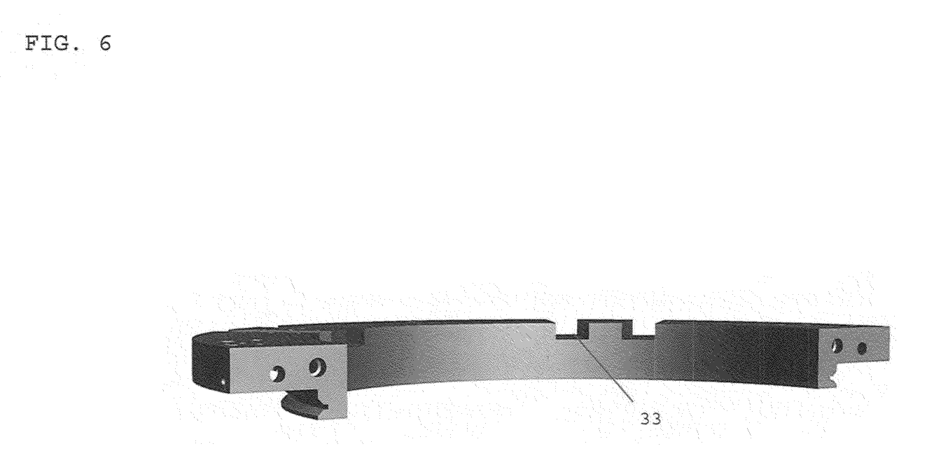

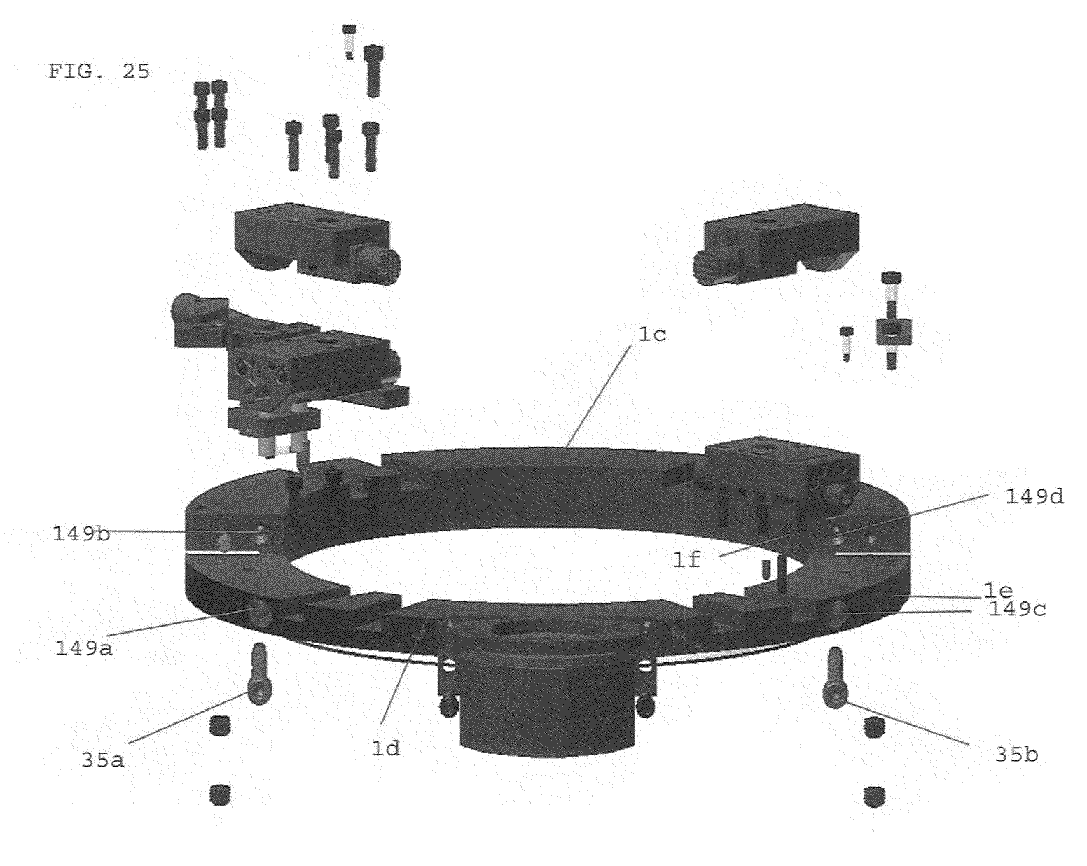

The base ring assembly is further detailed in FIG. 5. The base ring assembly comprises a base ring 1 having a first half 1c and a second half 1d, which when assembled define an annular member meeting a first interface 2a and a second interface 2b. The base ring 1 is designed with one or more slots 33 for accepting a leg system assembly 5. The slots 33 are further detailed in FIG. 6 and FIG. 7. The base ring 1 is designed to attach to a gear housing assembly 11 and one or more trip system assemblies 9. The base ring 1 has an internal v-groove 27 (as shown in FIG. 7) designed to connect with the internal bearing system from the gear ring. In one embodiment, the first half of the base ring 1c and the second half of the base ring 1d are connected by a joining member, such as a one screw. This method of connecting the first half of the base ring and the second half of the base ring ensures that the base ring maintains a circular alignment and will not pull apart when the legs of the base ring clamp the workpiece. The embodiment depicted in FIG. 5, incorporates two screws 35a and 35b to connect the first 1c and second 1d halves of the base ring. Referring now to FIG. 25, the two screws 35a and 35b enter the base ring outer circumferential surface 1e through an opening 149a and 149c and extend across the interface of the two halves and into the other half of the base ring through openings 149b and 149d. In a preferred embodiment, the screws 35a and 35b extend through the interfaces of the base ring at a point that is approximately three times further from the base ring outer circumferential surface 1e than it is from the base ring inner circumferential surface 1f.

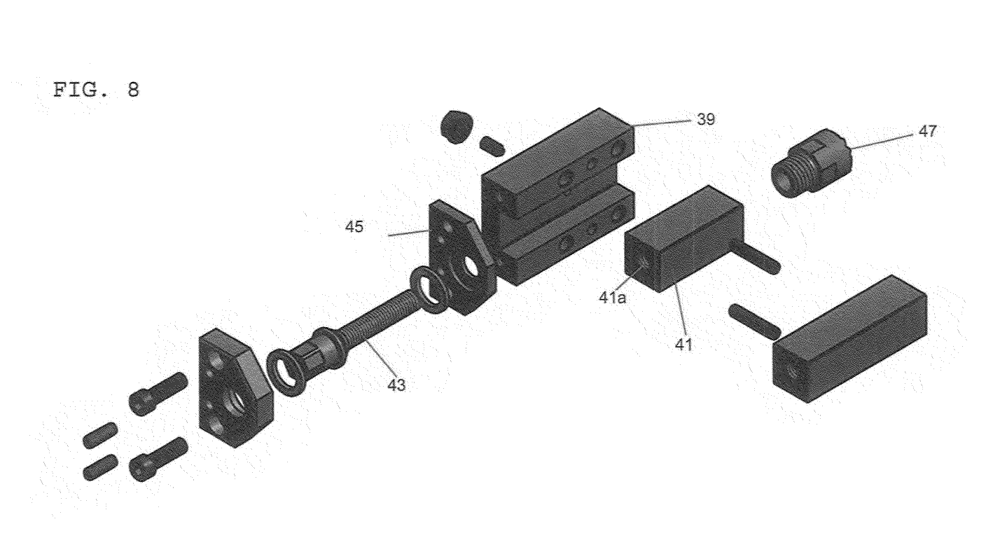

Referring back to FIG. 1 an adjustable leg 5 is shown mounted to the base ring external surface 1a as shown in FIG. 1 the base ring may include a plurality of externally mounted adjustable legs. The legs are used to fit the base ring to a workpiece, such as a pipe. One embodiment of the adjustable leg(s) is shown in FIG. 8. Referring now to FIG. 8, it is seen that the leg mounting block 39 is fastened into a slot 33 located on the external surface of the base ring (shown in FIG. 1). The leg 41 is adjustably connected to the leg mounting block 39 by a manipulating device, such as a hex screw 43 that is inserted through a sub plate 45 into an opening 41a in the leg. The leg 41 is adjusted towards or away from the workpiece by rotating the manipulating device 43. The leg 41 is also designed to accept various leg pads 47, which may have different designs (such as, for example, smooth, diamond patterns, and pinpoint) on the end for securing the pipe or other workpiece. A variety of other pad designs also could be used. The different designs help to enhance gripping for different situations. In a preferred embodiment, the leg(s) 41 are shaped to prevent spinning and breakage, for example by being block shaped. Referring to FIG. 6, the slots 33 are further depicted. Preferably the base ring is about 1 inch thick and the slot(s) 33 for the leg(s) is about ½ inch deep by 1 inch wide this provides about ½ inch wall in the ring to maintain rigidity of the base ring.

The lathe may be powered by a variety of powering means including hydraulic or pneumatic/air lathe powering devices such as Ingersoll Rand 4800 series or Char-Lynn model 101-*1030-009 or larger. The power source is compatible with split frame lathes of various sizes.

In one embodiment, to enhance strength and reliability, Grade 4140 Pre-Hard steel can be used on all major components. Other components can be made using Alloy 954 Bronze, Alloy 6061 Aluminum (for guards and covers), and Grade 303 Stainless Steel (for guarding on ring perimeter) along with premium fasteners. A Nitride coating can then be applied, which hardens the surface of the material. As an additional measure the major ring components as well as several of the secondary components are coated with ON—C after being Nitraded. This additional step enhances the resistance to corrosion and increases the wear resistance of the steel.

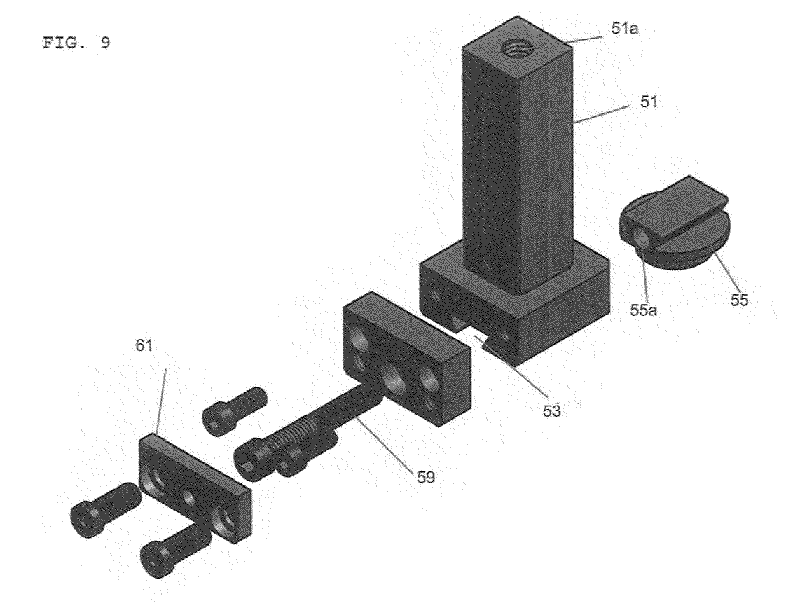

In another embodiment, the base ring is fitted to the workpiece by an adjustable leg system mounted to the base ring external surface with a mounting block 39. An adjustable leg system is depicted in FIG. 9. The leg block 51 includes a passage 53 at one end that is designed to slidably accept a dovetail leg 55 and has a threaded opening 51a on the other end. The leg block's 51 threaded opening Ma is designed to accept a manipulating device, such as a leg screw, that is capable of causing the leg block 51 to move in a radial direction with respect to the base ring (i.e. back and forth within the leg block) and therefore moves the leg block 51 towards or away from the workpiece in a manner that loosens or tightens the ring assembly's grip on the workpiece. The dovetail leg 55 also includes a threaded opening 55a that is capable of receiving a second manipulating device 59 that moves the dovetail leg 55 in an axial direction with respect to the base ring (i.e. causing the dovetail to slide back and forth within the passage 53). In one embodiment the manipulating devises are hex screws. In another embodiment, the adjustable leg system includes a locking plate 61 that maintains the dovetail leg 55 in a fixed position relative to the base ring.

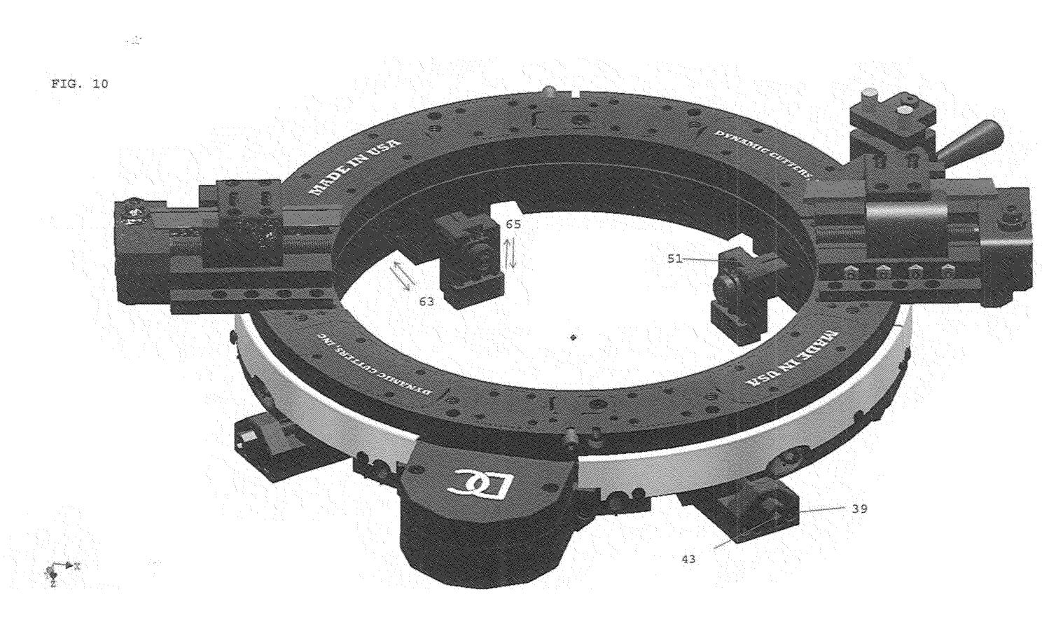

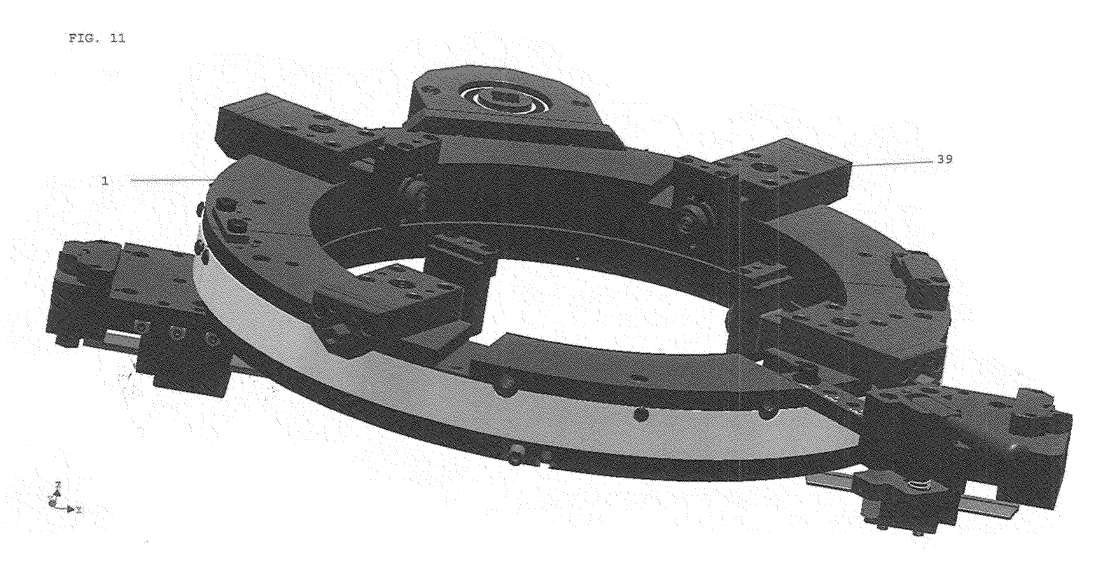

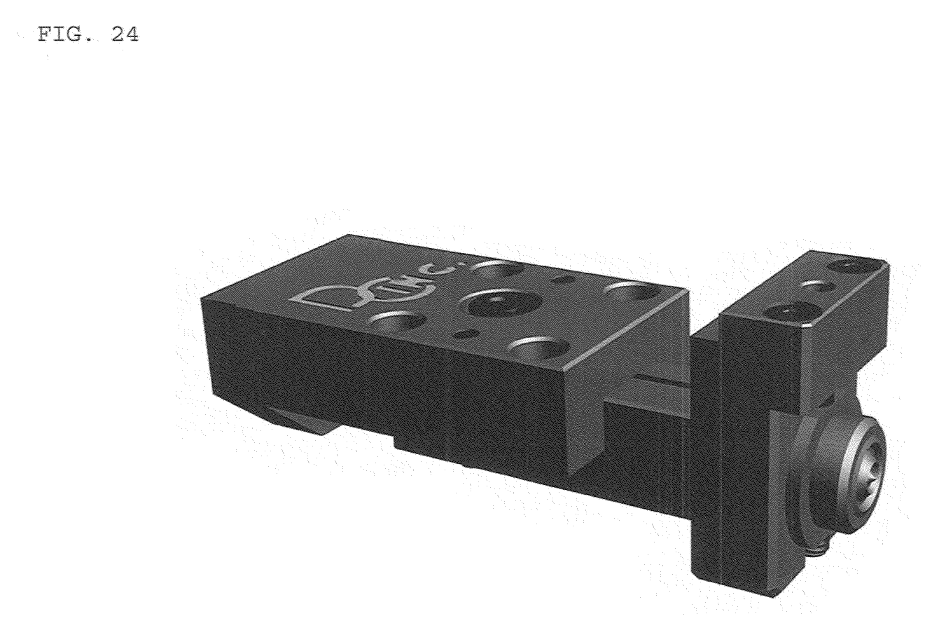

FIG. 10 shows one embodiment of the adjustable leg system attached to a split frame lathe as viewed from the gear ring. In FIG. 10 the manipulating device 43 is a hex screw that is operably engaged with the leg block 51 to enable it to slide in and out of the mounting block 39. However, other types of threaded adjustment devices or other adjustment devices also could be used. The adjustable leg system(s) can also be moved in a radial direction with respect to the base ring (towards and away from the workpiece) 63 and in an axial direction with respect to the base ring (along the workpiece) 65. This movement allows for increased gripping and allows the split frame lathe to pivot when cutting at an angle—such as, for example, when the workpiece includes a curve such as an elbow. This arrangement also allows for the split frame lathe to make angular cuts to the workpiece. Referring now to FIG. 11, the adjustable leg system(s) is shown attached to the split frame lathe as viewed from the base ring. It is seen that the adjustable leg system(s) comprise a leg block 51 that is adjustably connected to the leg mounting block 39. The leg mounting block externally mounts to the base ring 1. An embodiment of the assembled adjustable leg assembly is shown in FIG. 24.

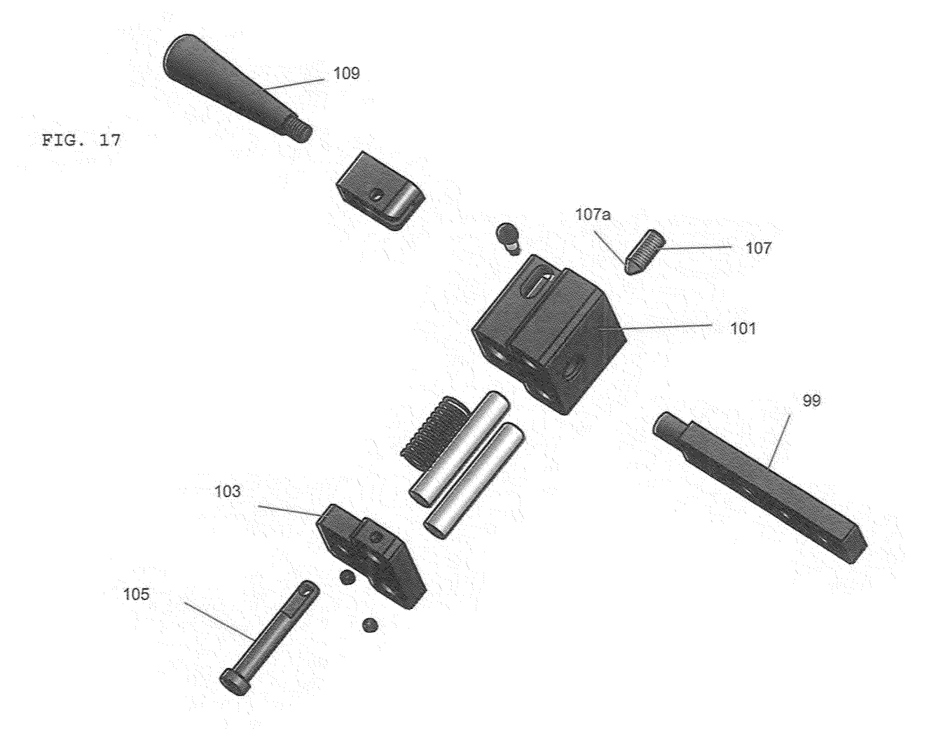

The ring assembly in FIG. 1 also shows a trip system assembly 9 mounted to the base ring 1. The trip system is further detailed in FIG. 17. The trip system is mounted to the base ring with a trip mount plate 99. The trip mount plate 99 is connected to a cam holder 101. In this embodiment, the cam holder 101 is connected to a pin holder 103 with a trip rod 107. The pin holder 103 accepts one or more pins 105. The pins 105 make contact with the star gear (described below) as the gear ring moves around the base ring. Each time the star gear engages one of the pin(s) 105 the star gear is rotated a predetermined amount. The trip rod 107 is sufficiently rigid to maintain the position of the trip system during normal engagement of the pins with the star gear. However, if the any of the pin(s) 105 come into contact with something other than the star gear, the trip rod is sufficiently deformable to allow the trip system to rotate out of the path of any component rotating with the gear ring. Thus, for example, if the pin(s) fail to connect with the star gear as intended and instead connects with a static object such as, for example, the slide base, the slide, or the gear box, the trip system will fold away. Thus, the trip system provides a mechanism by which, if the pin(s) are connecting with something other than the star gear, the pin(s) will be displaced from the rotational path of the gear ring. By displacing the pin(s) from the rotational path when the split frame lathe is misaligned, there is less likelihood that the split frame lathe will jam or undergo other mechanical malfunction and the potential for extensive damage is decreased. In the event of a failure, a user may therefore need to replace only a relatively inexpensive trip rod as opposed to potentially replacing the entire trip system or slide system. Once the trip cam holder 101 rotates away it can be realigned and locked back into place using the trip handle 109. In a preferred embodiment, the trip cam holder 101 rotates the pins 105 away from the gear ring (not pictured) by use of a screw 107 with a beveled end 107a. In another embodiment, the trip system(s) may include multiple pins and the base ring may accept multiple trip systems.

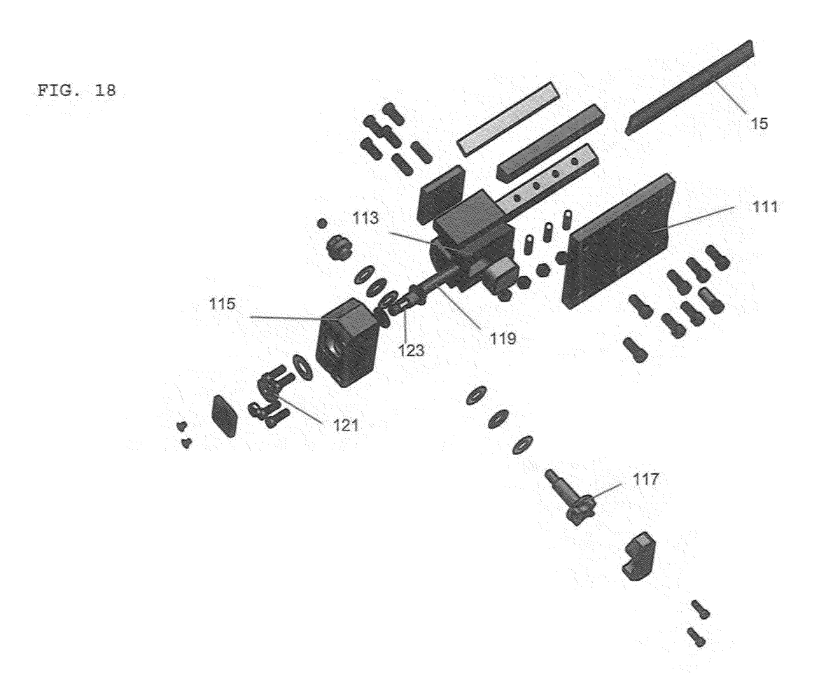

In one embodiment, the trip system is designed to interact with the slide system assembly detailed in FIG. 18. One or more slide system assemblies are fitted to the gear ring with the slide base 111. The slide system assembly comprises the slide base 111 which is connected to a slide 113. The slide 113 houses at least one cutting tool 15. The slide 113 also includes gearing. In this embodiment the gearing comprises a worm gear 121, such as 2-Start RH 24DP 14.5 PA CTO, connected to a slide gear box 115. The slide gear box 115 is connected to the slide 113 by a slide lead screw 119 and a lead screw 123. The slide gear box 115 is also connected to a star gear 117. As the gear ring rotates on the base ring the star gear 117 makes contact with the pins of the trip system and is turned a predetermined amount. With each turn of the star gear 117, the star gear connects with the worm gear 121 and the worm gear connects with the slide lead screw 123 and lead screw 123. The screws are then turned and move the cutting tools 15 towards the pipe or other workpiece. The star gear 117 is substantially symmetrical and is capable of bi-directional movement by rotating in either a clockwise or a counterclockwise direction. Therefore, the star gear 117 can be rotated in a first direction causing radially inward movement of the cutting tool(s) 15 or a second direct causing radially outward movement of the cutting tool(s) 15. For example, referring to FIG. 20, when the lathe is mounted on an external surface of the workpiece and disposed for cutting the workpiece from the outer surface along an outer circumference of the workpiece inwards, the star gear is capable of moving the cutting tool 15 of the slide system 13 radially inward towards (arrow 137a) when rotated in a first direction or radially outward (arrow 137b) when rotated in a second direction opposite the first direction. In a preferred embodiment, the star gear 117 rotates 90 degrees with each contact with a pin of the trip system. If more aggressive cutting is desired an increased number of pins and trip systems may be utilized. This will increase the number of turns of the star gear with each revolution of the gear ring. For example, each time the star gear makes contact with a pin from the trip system and turns 90 degrees the cutting tool is moved 0.002 inches. The amount of movement is dictated by the slide assembly. To accomplish more aggressive cutting, more pins may be added to the trip system.

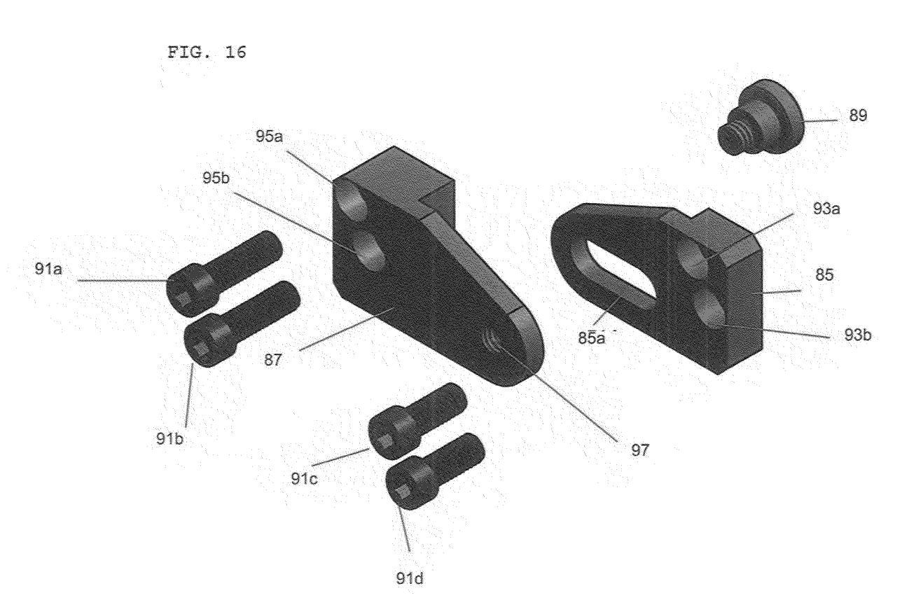

In one embodiment, the split frame lathe incorporates a hinge system on the base ring. The hinge system allows for the split frame lathe to be assembled around a workpiece by a single individual. This is useful in situations such as fitting split frame lathes to piping under water. The hinge system is located between the first and second halves of the base ring at one of the two interfaces. A hinge system for the split frame lathe is detailed in FIG. 16. The hinge system comprises a first hinge element 85 mounted to the first half of the base ring and a second hinge element 87 mounted to the second half of the base ring. The hinge system may be mounted on the base ring by, for example boring threaded holes into the external surface of the base ring. The hinge system can be fastened to the ring with, for example, screws 91a, 91b, 91c, and 91d. The first hinge element 85 includes an elongated opening 85a at a first end thereof, and two additional mounting openings 93a and 93b at a second end distal said first end. The openings are designed to accommodate fasteners such as screws 91c and 91d to mount the first hinge element to a half of the base ring. The second hinge element 87 includes two mounting openings 95a and 95b, designed to accommodate fasteners such as screws 91a and 91b to mount the first hinge element to a second half of the base ring, and an opening 97, such as a threaded shoulder screw opening. The first hinge element 85 and the second hinge element 87 can be slidably and pivotally connected with a fastener 89 such as a shoulder screw, which extends through the elongated opening 85A and engages the shoulder screw opening 97 of the second hinge element. One embodiment of the split frame lathe shown in FIG. 5 includes a joining member 35a connecting the first interface 2a of the first and second halves of the base ring 1 and a joining member 35b connecting the second interface 2b of the first and second halves of the base ring 1, the base ring 1 may also include a hinge system 7 joining one of the two interfaces.

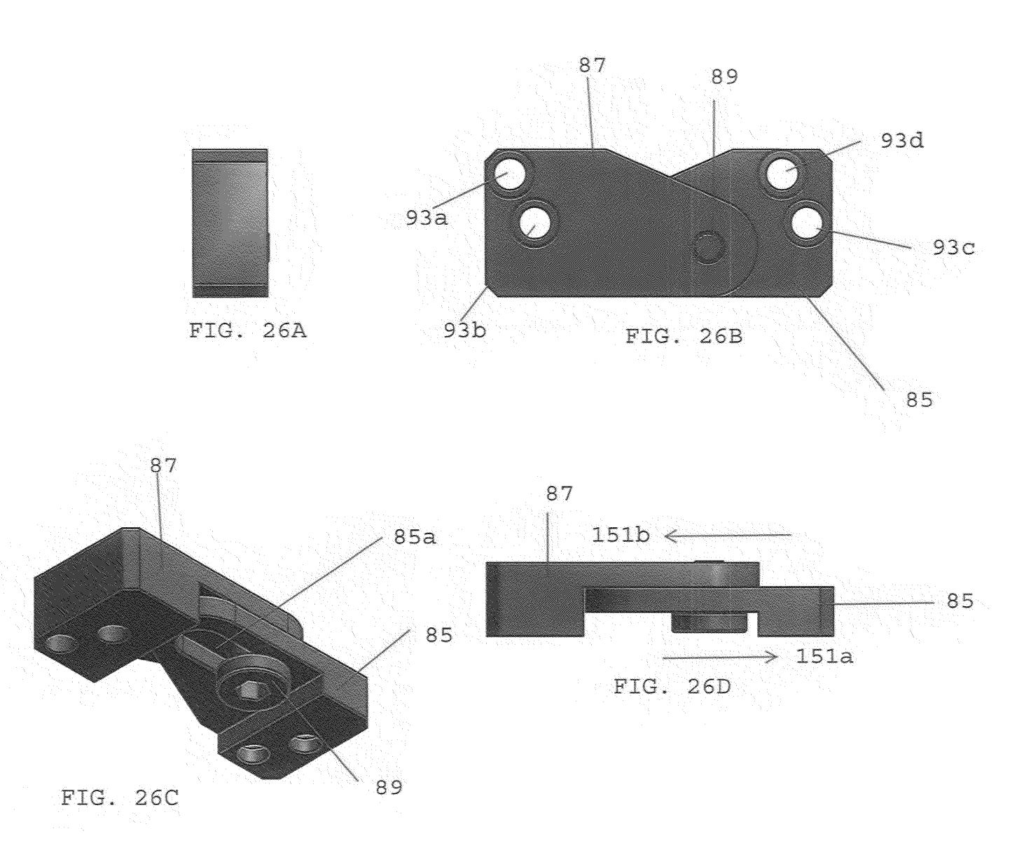

Referring now to FIG. 26B, a top view of an embodiment of the assembled hinge system is shown with the first hinge element 85 and the second hinge element 87 connected with a fastener 89, such as a shoulder screw. The first hinge element 85 and the second hinge element 87 include openings 93a, 93b, 93c, and 93d designed to accept a means to fasten the hinge system to the base ring, for instance screws. Referring now to FIG. 26C the first hinge element 85 includes an elongated opening 85a that is capable of accepting a fastener 89. The fastener 89 then slidably and pivotally connects the first hinge element 85 to the second hinge element 87 through the elongated opening 85a (as shown in FIGS. 16 and 26c). Referring to FIGS. 26C and 26D, the elongated opening 85a permits the first hinge element 85 to slide away from and toward the second hinge element 87 as shown by arrow 151a and 151b. The first hinge element 85 and the second hinge element 87 are also able to pivot around the fastener 89. In a preferred embodiment, the elongated opening of the hinge system allows the ring to spread by approximately ½ inch.

The gear housing assembly is shown in more detail in FIG. 15. A gear housing assembly is slidably mounted to the base ring with a mounting plate 81. The gear housing assembly includes a drive gear 83 and a power source 135 (as shown in FIG. 20). As shown in FIG. 20 the gear housing assembly connects to the power source 135. In one embodiment, the gear housing assembly is slidably mounted to the base ring by an external attachment. This allows the gear housing assembly to be adjusted along the base ring even after the base ring is fitted to the workpiece.

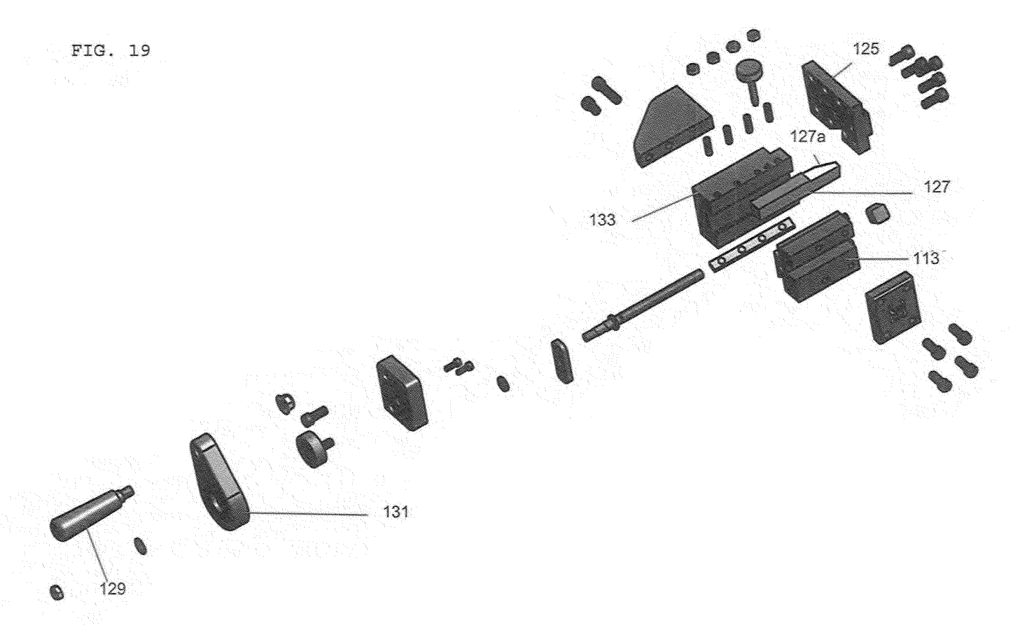

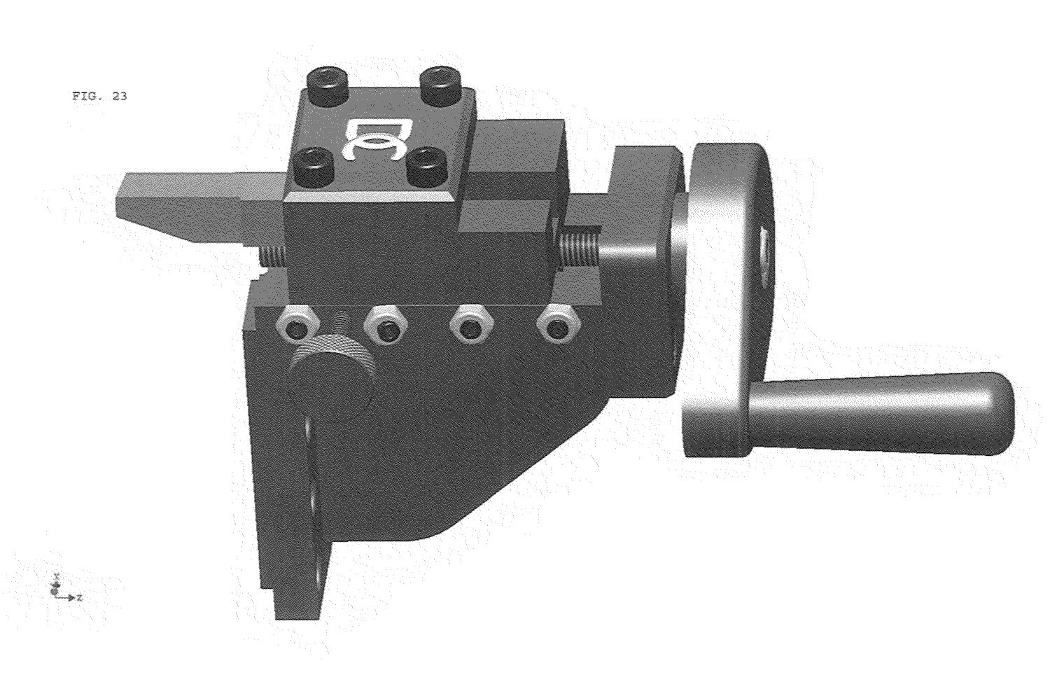

A counter bore attachment is an alternate embodiment that is detailed in FIG. 19 and allows for cutting and shaping, including beveling, of the inner diameter of the pipe or other workpiece. The counter bore attachment is an alternative cutting tool that attaches to the slide base 111 (as shown in FIG. 18) with a slide adapter 125 and slide 113. The counter bore tool 127 is capable of being positioned in the interior of the pipe. The counter bore tool 127 includes an angled end 127a that may be used to shape, for example by beveling, the front surface of a pipe. The counter bore tool 127 can have a variety of angled tools. It also may be used to cut the inner diameter of the pipe. The counter bore tool 127 can be set into position by a counter bore handle system. The counter bore handle system comprises a handle 129 which connects to a crank device 131 and gib plate 133. The counter bore handle system is capable of adjusting the counter bore tool 127 so that it is aligned correctly with the pipe. An assembled embodiment of the counter bore attachment is shown in FIG. 23.

For ease of reference, referring to FIG. 21, the counter bore assembly 139 is shown mounted to a workpiece in the form of a pipe 141 having a proximal end 143 and a distal end 145, with the proximal end 143 being where the cutting is taking place and the distal end 145 being the end extending laterally along the pipe surface away from the cutting end. The pipe has an inner 141a and an outer 141b circumferential surface. In this embodiment, the counter bore tool is capable of being moved towards the proximal end of the pipe while being mounted in the inner circumferential surface 141a of the pipe. The counter bore assembly 139 can, for example, be mounted to cut on the inner circumferential surface 141a of the pipe either on interior of the pipe or at the proximal end of the pipe to shape or shorten the length of the pipe through cutting at the proximal end. In this embodiment, the star gear is substantially symmetrical and capable of rotating both counterclockwise or clockwise when the star gear connects with a pin(s) form the trip system assembly detailed in FIG. 17. For example, if the clockwise rotation of the star gear causes cutting and shaping from the outer surface of the workpiece to the inner surface then the counterclockwise rotation of the star gear will cause cutting or shaping to proceed from the inner surface of the workpiece towards the outer surface, thus cutting and shaping the inner diameter of the workpiece. In a preferred embodiment, the star gear is turned 90 degrees with each contact with a pin from the trip system. If more aggressive cutting is desired, other embodiments of the present invention have an increased number of pins and trip systems. This will increase the number of turns of the star gear with each revolution of the gear ring. For example, each time the star gear makes contact with a pin from the trip system and turns 90 degrees the cutting tool is moved approximately 0.002 inches. The amount of movement is dictated by the slide assembly. To accomplish more aggressive cutting, more pins may be added to the trip system.

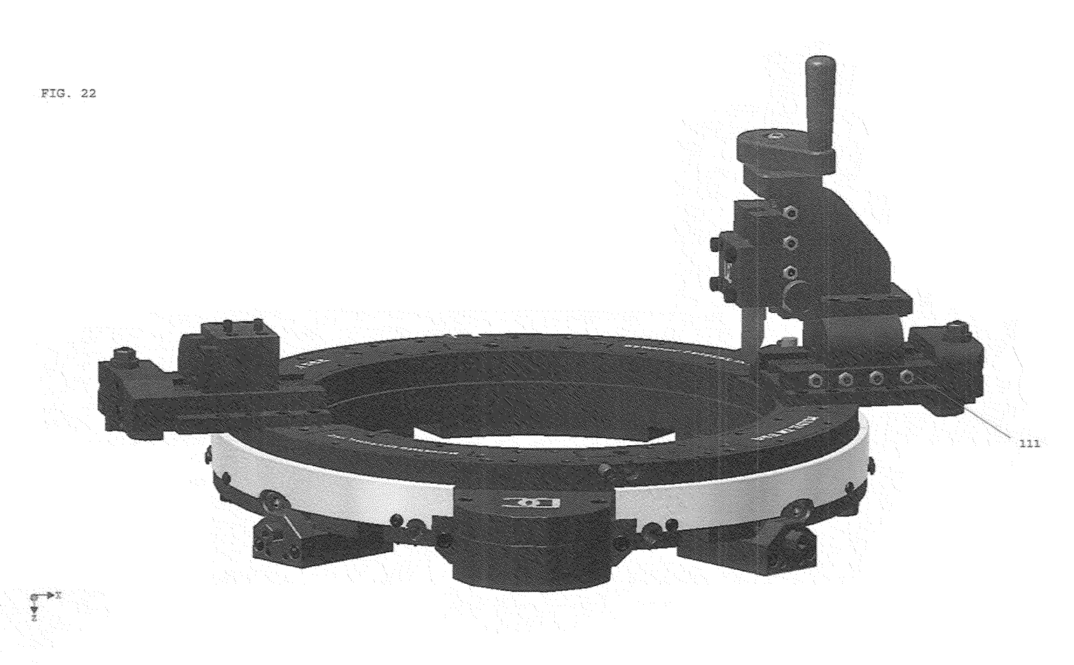

Referring now to FIG. 22, it is seen that the counter bore assembly mounted to a split frame lathe with a slide base 111.

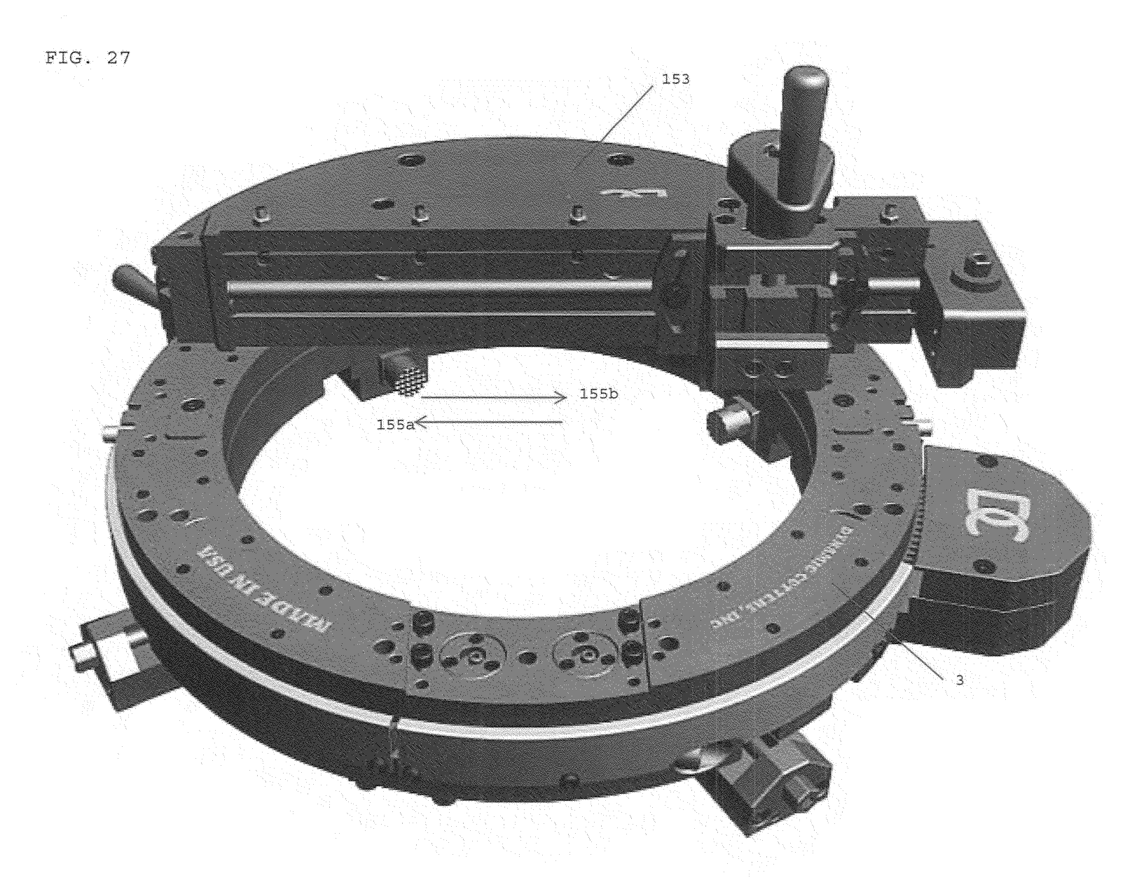

An alternative embodiment includes a flange facer attachment as detailed in FIGS. 27-29. The flange facer attachment 153 is an alternative cutting tool that attaches to the gear ring 3 as shown in FIG. 27 and allows for the cutting of custom-finishes to seal gaskets or to completely re-engineer the flange. Such an attachment also can be used to reface flanges that have deteriorated due to a variety of conditions, including metal erosion. Typically, flange facing or refacing is performed by an entirely separate machine, not as an attachment to a split frame lathe. This embodiment is directed to a flange facer attachment that can be mounted directly to the gear ring or a split frame lathe.

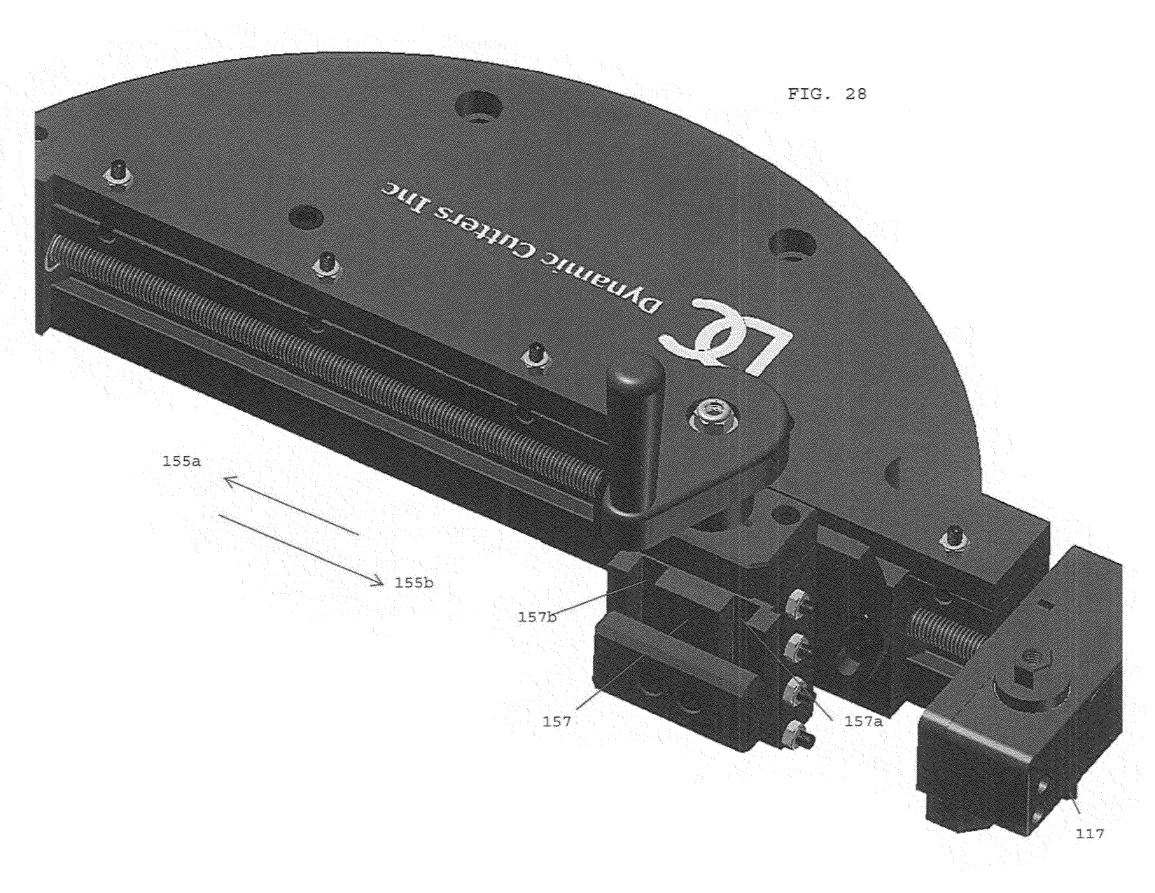

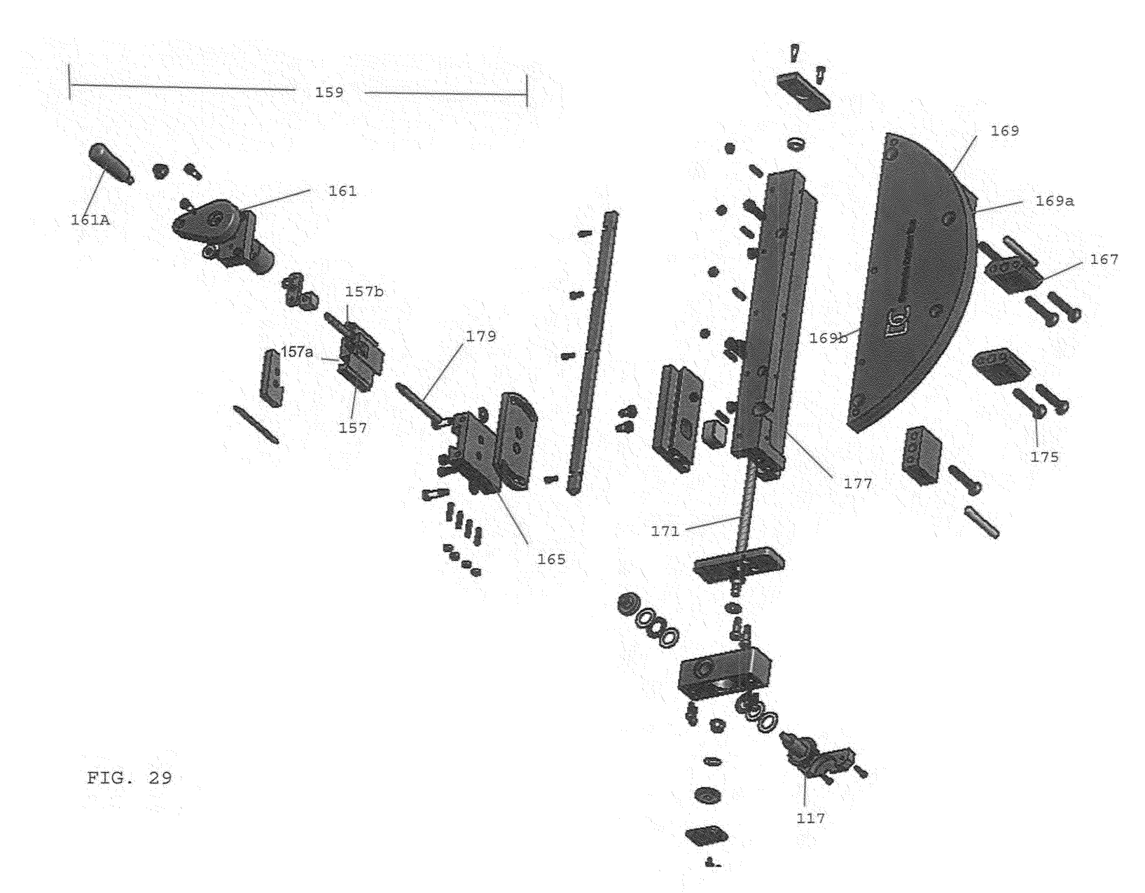

Referring to FIG. 28, the slide is shown assembled with the flange facer dovetail 157 and the two precut slots 157a and 157b designed to accept a cutting tool. One slot is designed to cut on the inner diameter and the other slot is used to cut on the outer diameter. Referring to FIG. 29, in this embodiment, the flange facer attachment attaches to the gear ring with a mounting plate 169 after first removing the slide assemblies from the gear ring. The mounting plate 169 is then secured to the gear ring with a fastening mechanism, for instance, a series of risers 167 and screws 175. In this embodiment the mounting plate 169 has a curved side 169a and a flat side 169b. In one embodiment the flat side 169b of the mounting plate is approximately 1-inch thick. The cross-feed (e.g., movement across the face of the flange) may be automated and controlled by the interaction between a star gear and one or more pins. A cross-feed assembly is attached to the flat side 169a of the mounting plate. The cross-feed assembly comprises gib plate 177, threaded member 171 which moves the cutting tool radially relative to the gear ring. When placed on the gear ring and put into motion, the star gear 117 will come into contact with the pin(s) connected to the base ring, for example the pin(s) of the trip system(s) (not pictured). The pin(s) of the trip system(s) will rotate the star gear 117 and move the threaded member 171 along to control the cross-feed. The movement of the cross-feed may be manipulated depending on the number of pin(s) used. Preferrably, the star gear is capable of turning 90 degrees with each contact with a pin. The more pins placed on the base ring the more aggressive the flange facer will move across the flange. In one embodiment, the star gear 117 is symmetrical and capable of rotating clockwise and counterclockwise. The flange facer attachment also comprises a tool post 159, which is connected to the cross-feed assembly. The tool post 159 comprises a slide 165, a threaded rod 179, a flange facer dovetail 157, a hand crank which is comprised of a crank 161 and a handle 161A. The in-feed, or adjustment of the depth of the flange facer attachment of the flange facer attachment may be manually set, for example, by using the hand crank. As the hand crank is turned the threaded rod 179 moves the flange facer dovetail 157 along the slide 165 to manually control the in-feed which positions the cutting tool in an axial direction relative to the gear ring. In a preferred embodiment the in-feed function of the flange facer attachment is capable of controlling precise depths to within approximately 0.001″.

Referring to FIGS. 27 and 28, the automatic cross-feed of the flange facer attachment is further described. In this embodiment, the flange facer cross-feed movement is accomplished by an interaction between the star gear and one or more pin(s) of the trip system. The trip system is described in more detail above. As the flange facer attachment 153 rotates on the gear ring 3, the star gear 117 will come into contact with the pin(s) mounted on the base ring. The star gear 117 rotation in the clockwise direction moves the flange facer cross-feed in direction of arrow 155A, whereas the star gear 117 rotation in the counterclockwise direction moves the cross-feed in direction of arrow 155B. In an alternative embodiment, the tool post 159 that controls the manual in-feed can be moved in the axial direction relative to the gear ring and can be tilted radially inward or radially outward from the axial direction. In a preferred embodiment the tilt is up to 27 degrees radially inward or radially outward from the axial direction. In another preferred embodiment, the flange facer attachment can be utilized with the adjustable lag assembly to allow for re-facing or re-engineering workpiece components that are at an angle or elbow.

From the foregoing it will be observed that numerous modifications and variations can be effectuated without departing from the true spirit and scope of the novel concepts of the present invention. It is to be understood that no limitation with respect to the specific embodiments illustrated is intended or should be inferred.

We claim:

1. A split frame lathe comprising:
a stationary base ring comprising a v-groove;
a gear ring;
a cutting tool coupled to the gear ring; and
at least one internal bearing system rotatably connecting the gear ring to the stationary base ring, each of the at least one internal bearing systems comprising:
an eccentric bushing defining an off-center bore extending through an axial length of the eccentric bushing;
a bearing pin inserted into the off-center bore of the eccentric bushing;
a v-bearing that rotates around the bearing pin and that is in mateable relation with the v-groove; and
a locking mechanism that secures the internal bearing system to the gear ring and that fixes an angular orientation of the eccentric bushing with respect to the gear ring;
wherein a radial position of the v-bearing relative to the gear ring depends on an arcuate position of the off-center bore and, consequently, on the angular orientation of the eccentric bushing with respect to the gear ring.

2. The split frame lathe of claim 1, wherein the radial position of the v-bearing, of a particular one of the at least one internal bearing systems, relative to the gear ring can be adjusted as much as about ⅛^{th} of an inch by changing the angular orientation of the eccentric bushing, of the particular internal bearing system, before the locking mechanism, of the particular internal bearing system, secures the particular internal bearing system to the gear ring.

3. The split frame lathe of claim 1, wherein
the gear ring comprises at least one pocket;
a head of the eccentric bushing, of a particular one of the at least one internal bearing systems, nests in one of the at least one pockets; and
the locking mechanism, of the particular internal bearing system, comprises a bearing clamp that holds in place the eccentric bearing, of the particular internal bearing system, fixing its angular orientation with respect to the gear ring.

4. The split frame lathe of claim 1,
wherein the stationary base ring has an internal surface that faces the gear ring, and has an opposite-facing external surface that defines a plurality of slots that are spaced around the stationary base ring;
the split frame lathe further comprising a plurality of adjustable legs for securing the stationary base ring to a workpiece, each of the plurality of adjustable legs being externally mounted to the stationary base ring in a respective one of the slots.

5. The split frame lathe of claim 1, further comprising:
at least one pin coupled to the stationary base ring; and
a slide system mounted to the gear ring, the cutting tool being mounted to the slide system, the slide system comprising:
a star gear that can be rotated both in a first direction and, alternatively, in an opposite second direction; and
gearing that converts rotation of the star gear in the first direction into radially inward movement of the cutting tool, and that converts rotation of the star gear in the second direction into radially outward movement of the cutting tool;
wherein each of the at least one pins is positioned and dimensioned to engage the star gear during normal rotation of the gear ring relative to the stationary base ring, so that the pin causes the star gear to rotate a predetermined amount with each engagement between the pin and the star gear, and so that the pin can cause the star gear to rotate in the first direction and, alternatively, in the second direction depending on a direction in which the gear ring is rotating relative to the stationary base ring.

6. The split frame lathe of claim 5, wherein the cutting tool comprises an automated counter bore attachment that is structured and dimensioned to be positioned inside a workpiece and to cut an interior surface of the workpiece.

7. The split frame lathe of claim 1, further comprising:
at least one pin coupled to the stationary base ring; and
a flange facer mounted to the gear ring, the cutting tool being mounted to the flange facer and being structured and dimensioned to be positioned at an axial end of a workpiece, the flange facer further comprising:
a rotatable star gear, with each of the at least one pins being positioned and dimensioned to engage the star gear during normal rotation of the gear ring relative to the stationary base ring, so that the pin causes the star gear to rotate a predetermined amount with each engagement between the pin and the star gear;
an automatic cross-feed assembly that is coupled to the star gear, and that converts rotation of the star gear into radial movement of the cutting tool relative to the gear ring; and
a manual in-feed assembly that is structured to adjust a position of the cutting tool in an axial direction relative to the gear ring.

8. The split frame lathe of claim 1, further comprising:
a rotatable star gear coupled to the gear ring, with the cutting tool being coupled to the star gear so that rotation of the star gear causes radial movement of the cutting tool; and
at least one trip system that is rotatably mounted to the stationary base ring, each of the at least one trip systems comprising:
at least one pin, each of the at least one pins being positioned and dimensioned to engage the star gear during normal rotation of the gear ring relative to the stationary base ring, so that the pin cause the star gear to rotate a predetermined amount with each engagement between the pin and the star gear; and
a trip rod that is sufficiently rigid to maintain a position the trip system during normal engagement of the at least one pin with the star gear, but that is sufficiently deformable to allow the trip system to rotate out of a path any component rotating with the gear ring if any of the at least one pins engages any object other than the star gear.

9. The split frame lathe of claim 1 further comprising:
a hinge system connecting first and second halves of the stationary base ring at an interface between the first half and the second half of the stationary base ring, the hinge system comprising:
a first hinge element mounted to the first half of the stationary base ring;
a second hinge element mounted to the second half of the stationary base ring, the second hinge element defining an elongated opening; and
a fastener extending through the elongated opening of the second hinge element, and connecting the first and second hinge elements to each other while allowing them to slide and to pivot with respect to each other when the fastener is free to move laterally and to rotate within the elongated opening of the second hinge element.

10. The split frame lathe of claim 1,
wherein the stationary base ring comprises two complimentary halves, each half of the stationary base ring having an inner circumferential surface and an outer circumferential surface;
wherein the two halves of the stationary base ring meet at two interfaces and are locked together by at least one joining member; and
wherein each of the at least one joining member enters one of the two halves of the stationary base ring through the outer circumferential surface of that one of the two halves, and extends across one of the two interfaces and into the other one of the two halves of the stationary base ring.

11. The split frame lathe of claim 10, wherein each of the at least one joining member extends through one of the two interfaces at a point that is located about three times further from the outer circumferential surfaces of each of the two halves than it is located from the inner circumferential surfaces of each of the two halves of the stationary base ring.

12. The split frame lathe of claim 1,
wherein the gear ring comprises two complimentary halves, each half of the gear ring having an inner circumferential surface and an outer circumferential surface;
wherein each one of the two halves of the gear ring defines a locking assembly pocket that is located further from the outer circumferential surface of that half of the gear ring than it is located from the inner circumferential surface of that half of the gear ring;
wherein one of the two halves of the gear ring defines a pin hole that extends from the outer circumferential surface of that half of the gear ring to the locking assembly pocket of that half of the gear ring;
wherein the two halves of the gear ring meet at two interfaces and are locked together by a locking assembly, the locking assembly comprising a locking member and at least two elongated fasteners; and
wherein the two locking assembly pockets meet at one of the two interfaces, the locking member is disposed in the two locking assembly pockets and extends across the one of the two interfaces, one of the at least two elongated fasteners extends through the pin hole of the gear ring and into the locking member, and another one of the at least two elongated fasteners extends in a generally axial direction with respect to the gear ring and joins the locking member to the gear ring.

13. A split frame lathe comprising:
a stationary base ring having an internal surface, and an opposite-facing external surface that defines a plurality of slots that are spaced around the stationary base ring;
a gear ring rotatably mounted to the stationary base ring, and facing the internal surface of the stationary base ring;
a cutting tool coupled to the gear ring; and
a plurality of adjustable legs for securing the stationary base ring to a workpiece, each of the adjustable legs being externally mounted to the base ring in a respective one of the slots.

14. The split frame lathe of claim 13,
each of the adjustable legs comprising a leg block that is slidably connected to the stationary base ring and a dovetail leg disposed within a complimentary passage in the leg block;
the leg block operably connected to a first manipulating device capable of moving the leg block in a radial direction with respect to the stationary base ring; and
the dovetail leg operably connected to a second manipulating device capable of moving the dovetail leg in an axial direction with respect to the stationary base ring.

15. The split frame lathe of claim 14 wherein each of the adjustable legs further comprising a locking plate for maintaining the dovetail leg in a fixed position relative to the stationary base ring.

16. A split frame lathe comprising:
a stationary base ring;
a gear ring rotatably mounted to the base ring;
a rotatable star gear coupled to the gear ring;
a cutting tool coupled to the star gear, so that rotation of the star gear causes radial movement of the cutting tool; and
at least one trip system rotatably mounted to the stationary base ring, each of the at least one trip systems comprising:
at least one pin, each of the at least one pins being positioned and dimensioned to engage the star gear during normal rotation of the gear ring relative to the stationary base ring, so that the pin causes the star gear to rotate a predetermined amount with each engagement between the pin and the star gear; and
a trip rod that is sufficiently rigid to maintain a position the trip system during normal engagement of the at least one pin with the star gear, but that is sufficiently deformable to allow the trip system to rotate out of a path any component rotating with the gear ring if any of the at least one pins engages any object other than the star gear.

17. The split frame lathe of claim 16 wherein the trip rod is a screw with one end beveled to a point.

18. A split frame lathe comprising:
a stationary base ring;
a gear ring rotatably mounted to the stationary base ring;
at least one pin coupled to the stationary base ring;
a flange facer mounted to the gear ring; and
a cutting tool mounted to the flange facer, the cutting tool being structured and dimensioned to be positioned at an axial end of a workpiece, the flange facer comprising:
a rotable star gear, with each of the at least one pins being positioned and dimensioned to engage the star gear during normal rotation of the gear ring relative to the stationary base ring, so that the pin causes the star gear to rotate a predetermined amount with each engagement between the pin and the star gear;
an automatic cross-feed assembly that is coupled to the star gear, and that converts rotation of the star gear into radial movement of the cutting tool relative to the gear ring; and
a manual in-feed assembly that is structured to adjust a position of the cutting tool in an axial direction relative to the gear ring.

19. The split frame lathe of claim 18, wherein the star gear can be rotated both in a first direction and, alternatively, in an opposite second direction, so that the at least one pin can cause the star gear to rotate in the first direction and, alternatively, in the second direction depending on a direction in which the gear ring is rotating relative to the stationary base ring.

20. The split frame lathe of claim 18, wherein the manual in-feed assembly comprises a slide mechanism that can be moved in an axial direction relative to the gear ring, and that can be tilted to an orientation radially inward or radially outward from the axial direction.
